(19) United States
(12) Patent Application Publication
(10) Pub. No.: US 2026/0299388 A1
(43) Pub. Date: Oct. 1, 2026

(54) WAVELENGTH CONVERSION ELEMENT, LIGHT SOURCE DEVICE, AND PROJECTOR

(71) Applicant: SEIKO EPSON CORPORATION, Tokyo (JP)

(72) Inventor: Ryota TAKAI, MATSUMOTO-SHI (JP)

(21) Appl. No.: 19/629,205

(22) Filed: Mar. 26, 2026

(30) Foreign Application Priority Data
Mar. 27, 2025 (JP) 2025-053159

(51) Int. Cl. G03B 21/20; G03B 21/16

(52) U.S. Cl. CPC G03B 21/204; G03B 21/16

(57) ABSTRACT

A wavelength conversion element includes: a wavelength conversion member having a side surface extending in a first direction and a first surface crossing the side surface and disposed at one end in the first direction, and containing a phosphor configured to convert first light having a first wavelength band and incident on the side surface into second light having a second wavelength band different from the first wavelength band; a light transmissive member which has a second surface disposed at one end in the first direction, is disposed at the side surface along the first direction, and is configured to transmit the first light and the second light; and an angle conversion member bonded to the first surface and the second surface, and configured to convert an angle of light emitted from the first surface and the second surface, wherein a refractive index of the light transmissive member is smaller than a refractive index of the wavelength conversion member.

The present application is based on, and claims priority from JP Application Serial Number 2025-053159, filed Mar. 27, 2025, the disclosure of which is hereby incorporated by reference herein in its entirety.

### BACKGROUND

### 1. Technical Field

The present disclosure relates to a wavelength conversion element, a light source device, and a projector.

### 2. Related Art

In the related art, a projector that modulates light emitted from a light source device in accordance with image information and projects the modulated light is known. There is known a projector including, as a light source device adopted in such a projector, a first illumination device that emits yellow fluorescence and a second illumination device that emits blue light (see, e.g., JP-A-2023-108325).

The first illumination device provided to the projector described in JP-A-2023-108325 includes a light source unit that emits excitation light, a wavelength conversion member that performs wavelength conversion on the excitation light into fluorescence including a red light component and a green light component, and an angle conversion member provided to the wavelength conversion member.

The wavelength conversion member is formed in a quadrangular prism shape, and contains a phosphor that converts the excitation light having a first wavelength band into fluorescence having a second wavelength band different from the first wavelength band. The excitation light enters a side surface of the wavelength conversion member from the light source unit. The fluorescence generated by the phosphor in the wavelength conversion member is guided inside the wavelength conversion member and is then emitted from a first surface crossing the side surface.

The angle conversion member is a light transmissive member formed in a truncated quadrangular pyramid shape in which the cross-sectional area perpendicular to the optical axis increases toward the traveling direction of the fluorescence. The angle conversion member is fixed by bonding to a first end surface of the wavelength conversion member.

JP-A-2023-108325 is an example of the related art.

In the first illumination device described in JP-A-2023-108325, when the cross-sectional area of the wavelength conversion member orthogonal to the optical axis of the angle conversion member is reduced, etendue defined by a product of the area of the available light source and the solid angle of light is reduced, and the light use efficiency in an optical component in a posterior stage on the optical path to the angle conversion member can be improved.

However, when the cross-sectional area of the wavelength conversion member is reduced, the bonding area between the wavelength conversion member and the angle conversion member is reduced, and there is a problem that the angle conversion member is easily separated from the wavelength conversion member.

Therefore, a configuration capable of suppressing an increase in etendue and suppressing the separation of the angle conversion member has been desired.

### SUMMARY

A wavelength conversion element according to a first aspect of the present disclosure includes: a wavelength conversion member having a side surface extending in a first direction and a first surface crossing the side surface and disposed at one end in the first direction, and containing a phosphor configured to convert first light having a first wavelength band and incident on the side surface into second light having a second wavelength band different from first the wavelength band; a light transmissive member which has a second surface disposed at one end in the first direction, is disposed at the side surface along the first direction, and is configured to transmit the first light and the second light; and an angle conversion member bonded to the first surface and the second surface, and configured to convert an angle of light emitted from the first surface and the second surface, wherein a refractive index of the light transmissive member is smaller than a refractive index of the wavelength conversion member.

A light source device according to a second aspect of the present disclosure includes: the wavelength conversion element according to the first aspect described above; a light emitting element configured to emit the first light to the side surface; and a flow mechanism configured to circulate the liquid provided to the light transmissive member.

A light source device according to a third aspect of the present disclosure includes: the wavelength conversion element according to the first aspect described above; and a light emitting element configured to emit the first light to the side surface.

A projector according to a fourth aspect of the present disclosure includes: the light source device according to the second aspect described above or the third aspect described above; a light modulation device configured to modulate light including the second light emitted from the light source device; and a projection optical device configured to project the light modulated by the light modulation device.

### BRIEF DESCRIPTION OF THE DRAWINGS

FIG. 1 is a schematic diagram showing a configuration of a projector in a first embodiment.

FIG. 2 is a perspective view showing a light source device in the first embodiment.

FIG. 3 is a perspective view showing the light source device in the first embodiment.

FIG. 4 is an exploded perspective view showing the light source device in the first embodiment.

FIG. 5 is an exploded perspective view showing the light source device in the first embodiment.

FIG. 6 is a side view showing a fluorescence emitting device in the first embodiment.

FIG. 7 is a perspective view showing the fluorescence emitting device in the first embodiment.

FIG. 8 is a plan view showing a wavelength conversion element in the first embodiment.

FIG. 9 is a diagram showing an angle conversion member viewed from a light incident side in the first embodiment.

FIG. 10 is a perspective view showing the angle conversion member viewed from a light exit side in the first embodiment.

FIG. 11 is a perspective view showing a light guide in the first embodiment.

FIG. 12 is a plan view showing a wavelength conversion element provided to a light source device of a projector according to a second embodiment.

FIG. 13 is a perspective view showing a light guide provided to a light source device of a projector according to a third embodiment.

FIG. 14 is a schematic diagram showing a light guide and a circulation device provided to a light source device of a projector according to a fourth embodiment.

### DESCRIPTION OF EMBODIMENTS

### First Embodiment

A first embodiment of the present disclosure will hereinafter be described with reference to the drawings.

### Schematic Configuration of Projector

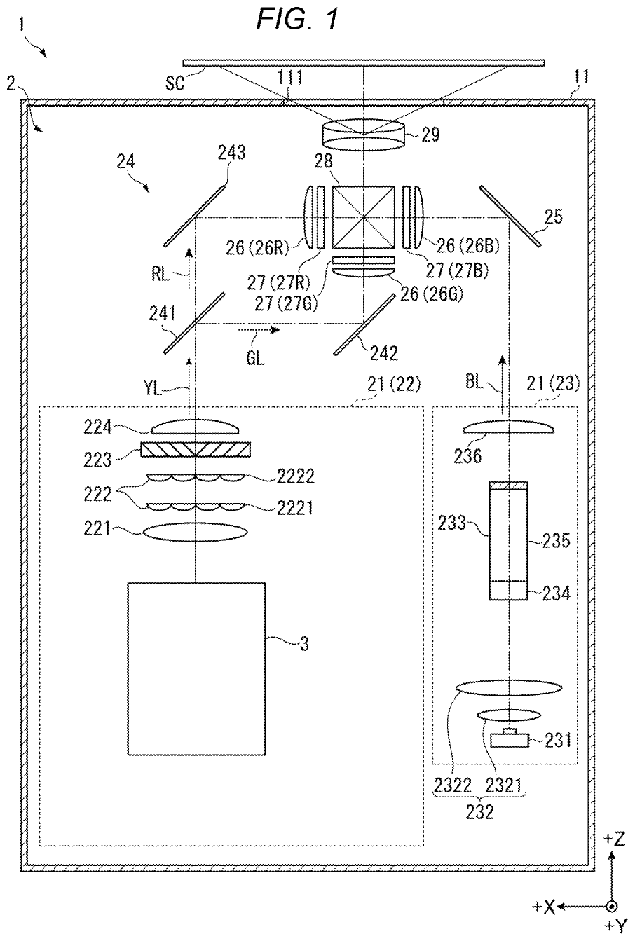

FIG. 1 is a schematic diagram showing a configuration of a projector 1 according to the present embodiment.

The projector 1 according to the present embodiment is a display apparatus that modulates the light output from a light source to form image light, enlarges the formed image light, and projects the enlarged image light onto a projection target surface SC such as a screen. The projector 1 includes an exterior enclosure 11, which constitutes the exterior of the projector 1, and an image projection apparatus 2 housed in the exterior enclosure 11, as shown in FIG. 1. In addition to the above, the projector 1 includes, although not shown, a control device that controls the operation of the projector 1, a cooling device that cools cooling targets, and a power supply device that supplies electronic parts that constitute the projector 1 with electric power.

### Configuration of Image Projection Apparatus

The image projection apparatus 2 projects image light according to image information under the control of the control device described above. The image projection apparatus 2 includes an illumination device 21, a color separation optical system 24, a reflection mirror 25, collimating lenses 26, light modulation devices 27, a color combining device 28, and a projection optical device 29.

The illumination device 21 includes a first illumination device 22, which outputs fluorescence YL containing green light GL and red light RL, and a second illumination device 23, which outputs blue light BL.

### Configuration of First Illumination Device

The first illumination device 22 irradiates the color separation optical system 24 with the fluorescence YL. The first illumination device 22 includes a light source device 3, a collimating optical system 221, an integrator optical system 222, a polarization conversion element 223, and a superimposing optical system 224.

The light source device 3 outputs the fluorescence YL. The configuration of the light source device 3 will be described later in detail.

The collimating optical system 221 collimates the fluorescence YL output from the light source device 3.

The integrator optical system 222 homogenizes the illuminance distribution of the fluorescence YL incident from the light source device 3 via the collimating optical system 221. In the present embodiment, the integrator optical system 222 includes a first lens array 2221 and a second lens array 2222. Although not shown in detail, the first lens array 2221 includes a plurality of first lenses arranged in a matrix, and the second lens array 2222 includes a plurality of second lenses corresponding to the plurality of first lenses. The first lens array 2221 divides the fluorescence YL incident from the collimating optical system 221 into a plurality of sub-luminous fluxes, each of which passes through the corresponding one of the plurality of second lenses. Note that the integrator optical system 222 may be configured with a rod integrator.

The plurality of sub-luminous fluxes output from the second lens array 2222 enters the polarization conversion element 223. That is, the fluorescence YL enters the polarization conversion element 223. The polarization conversion element 223 converts the incident fluorescence YL into one kind of linearly polarized light and outputs the linearly polarized fluorescence YL.

Out of the plurality of sub-luminous fluxes incident via the polarization conversion element 223, the superimposing optical system 224 causes the sub-luminous fluxes that constitute the green light GL to be superimposed on a modulation region of a green light modulation device 27G, and causes the sub-luminous fluxes that constitute the red light RL to be superimposed on the modulation region of a red light modulation device 27R. Note that the fluorescence YL output from the superimposing optical system 224 enters the color separation optical system 24.

### Configuration of Second Illumination Device

The second illumination device 23 irradiates the reflection mirror 25 with the blue light BL. The second illumination device 23 includes a blue light source 231, a light collection element 232, a homogenization device 233, and a relay lens 236.

The blue light source 231 has at least one light emitting element that emits the blue light BL.

The light collection element 232 converges the blue light BL output from the blue light source 231 on the homogenization device 233. The light collection element 232 includes, for example, a plurality of lenses 2321, 2322.

The homogenization device 233 homogenizes the illuminance distribution of the blue light BL incident from the light collection element 232. In the present embodiment, the homogenization device 233 includes a diffuser plate 234 and a rod integrator 235.

The relay lens 236 relays the blue light BL incident from the homogenization device 233 to the reflection mirror 25.

### Configurations of Color Separation Optical System and Reflection Mirror

The color separation optical system 24 separates the fluorescence YL incident from the first illumination device 22 into the green light GL and the red light RL, guides the green light GL to the green light modulation device 27G, and guides the red light RL to the red light modulation device 27R. The color separation optical system 24 includes a dichroic mirror 241 and reflection mirrors 242, 243.

The dichroic mirror 241 separates the fluorescence YL incident from the first illumination device 22 into the green light GL and the red light RL.

The reflection mirror 242 reflects, toward the green light modulation device 27G, the green light GL reflected by the dichroic mirror 241.

The reflection mirror 243 reflects, toward the red light modulation device 27R, the red light RL having passed through the dichroic mirror 241.

The reflection mirror 25 reflects, toward a blue light modulation device 27B, the blue light BL incident from the second illumination device 23.

### Configuration of Collimating Lens

The collimating lenses 26 are each a field lens that collimates incident light. The collimating lenses 26 include a blue collimating lens 26B, a green collimating lens 26G, and a red collimating lens 26R.

The blue collimating lens 26B is disposed between the reflection mirror 25 and the blue light modulation device 27B in the optical path of the blue light BL. The blue collimating lens 26B collimates the blue light BL to be incident on the blue light modulation device 27B.

The green collimating lens 26G is disposed between the reflection mirror 242 and the green light modulation device 27G in the optical path of the green light GL. The green collimating lens 26G collimates the green light GL to be incident on the green light modulation device 27G.

The red collimating lens 26R is disposed between the reflection mirror 243 and the red light modulation device 27R in the optical path of the red light RL. The red collimating lens 26R collimates the red light RL to be incident on the red light modulation device 27R.

### Configuration of Light Modulation Devices

The light modulation devices 27 are each an image forming device that modulates incident light in accordance with image information. The light modulation devices 27 include the blue light modulation device 27B, which modulates the blue light BL, the green light modulation device 27G, which modulates the green light GL, and the red light modulation device 27R, which modulates the red light RL.

In the present embodiment, the light modulation devices 27B, 27G, and 27R each include a transmissive liquid crystal panel and a pair of polarization plates sandwich the liquid crystal panel. That is, the light modulation devices 27 are each a transmissive liquid crystal light valve.

### Color Combining Device and Projection Optical Device

The colored light BL, GL, and RL modulated by the light modulation devices 27R, 27G, and 27B enters the color combining device 28. The color combining device 28 combines the incident colored light BL, GL, and RL to generate image light to be projected by the projection optical device 29. In the present embodiment, the color combining device 28 is configured with a cross dichroic prism, and may instead be configured with plurality of dichroic mirrors.

The projection optical device 29 projects the image light combined by the color combining device 28 onto the projection target surface SC via a projection port 111 of the exterior enclosure 11. That is, the projection optical device 29 projects the light modulated by the light modulation devices 27. Examples of the projection optical device 29 include a lens assembly including a plurality of lenses and a cylindrical lens barrel that houses the plurality of lenses.

### Configuration of Light Source Device

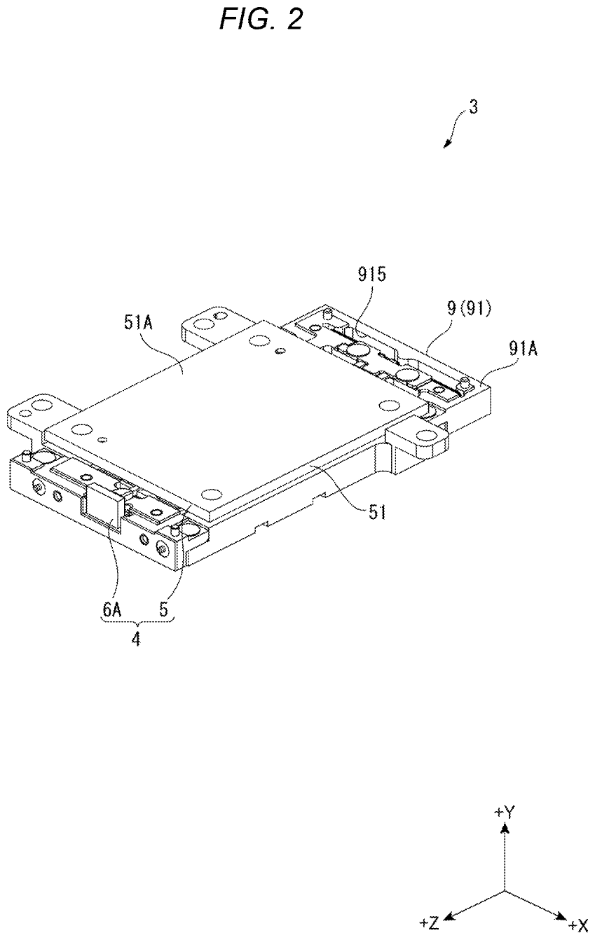

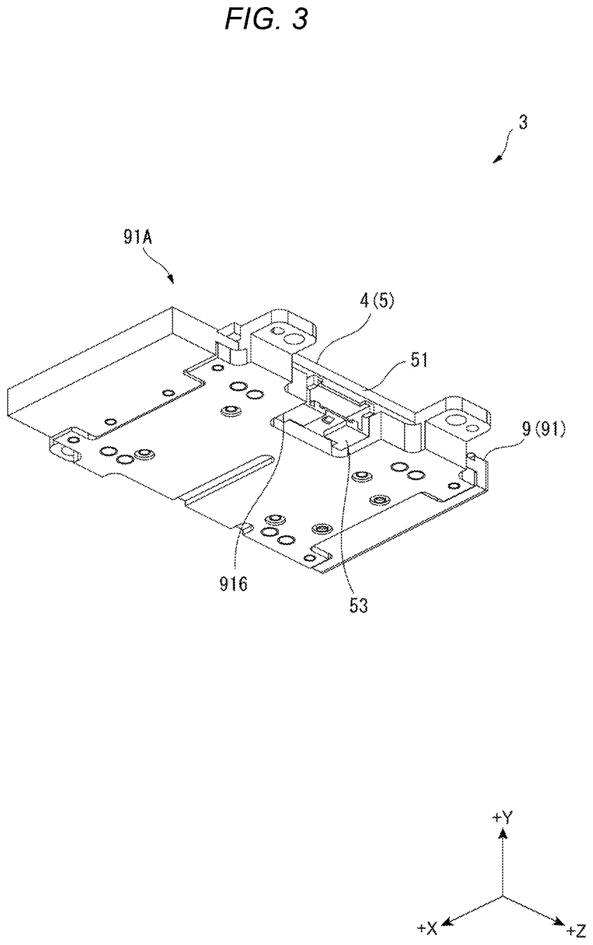

FIG. 2 is a perspective view showing the light source device 3 viewed from the exit side of the fluorescence YL, and FIG. 3 is a perspective view showing the light source device 3 viewed from the side opposite to the exit side of the fluorescence YL.

The light source device 3 includes a fluorescence emitting device 4 and a housing 9, which houses the fluorescence emitting device 4, as shown in FIGS. 2 and 3.

In the following description, three directions perpendicular to each another are defined as a +X direction, a +Y direction, and a +Z direction. It is assumed in the present embodiment that the +Z direction is the direction in which the light source device 3 outputs the fluorescence YL, and that the +Y direction is the direction in which a light source unit 5 is located with respect to a base 91 described later in the housing 9. It is assumed that the +X direction is the rightward direction when viewed from the +Z direction so that in the +Y direction faces to the upward direction. Although not shown in the drawings, a direction opposite to the +X direction is defined as a −X direction, a direction opposite to the +Y direction is defined as a −Y direction, and a direction opposite to the +Z direction is defined as a −Z direction.

### Configuration of Housing

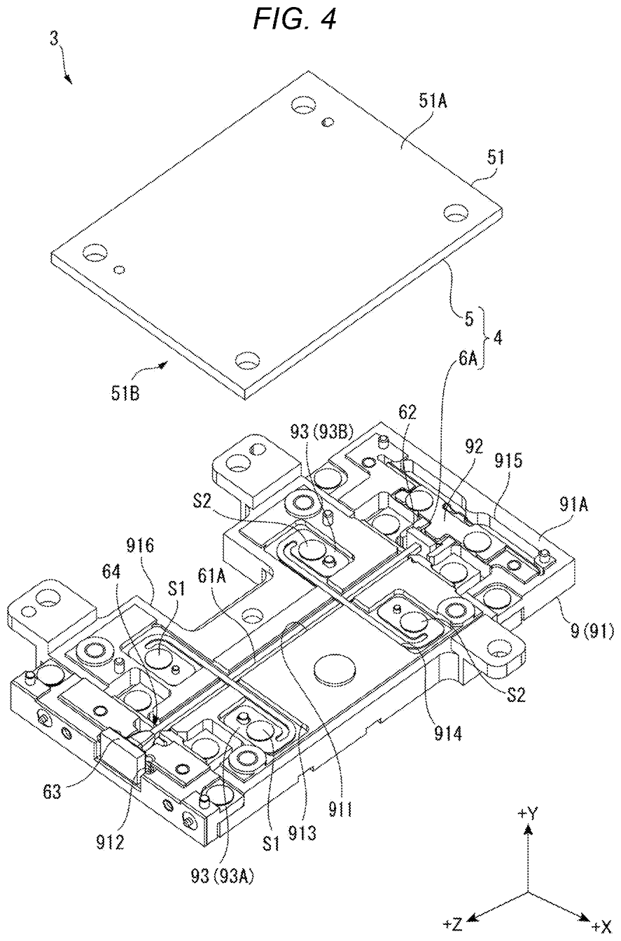

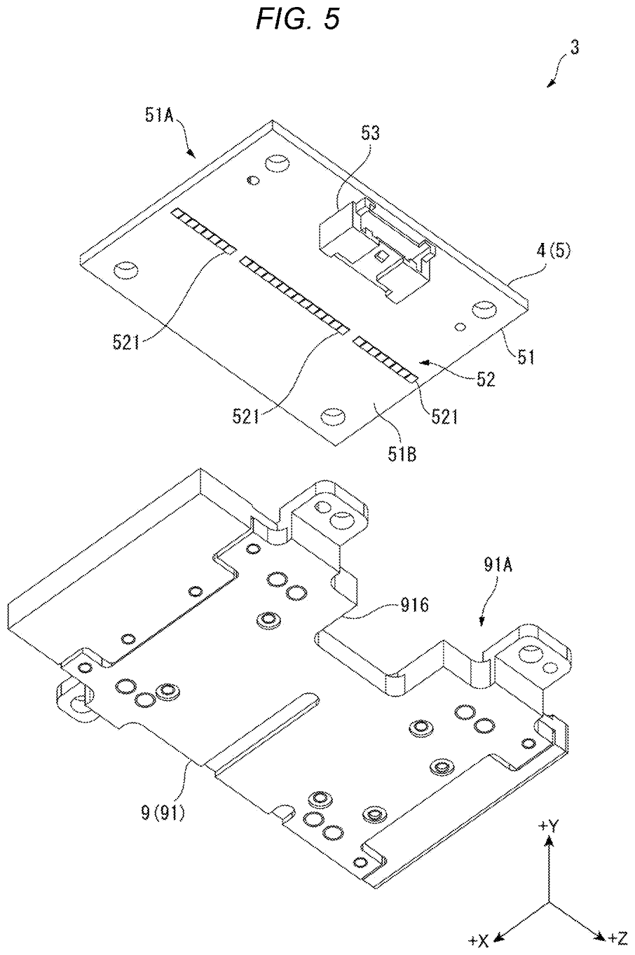

FIG. 4 is an exploded perspective view showing the light source device 3 viewed from the +Z direction, and FIG. 5 is an exploded perspective view showing the light source device 3 viewed from the −Z direction.

As shown in FIGS. 2 to 5, the housing 9 supports the fluorescence emitting device 4 and houses the fluorescence emitting device 4 inside. As shown in FIGS. 4 and 5, the housing 9 includes the base 91, a first biasing member 92, and two second biasing members 93. In addition, although not illustrated, the housing 9 includes a first cover member and a second cover member.

### Configuration of Base

The base 91 supports the wavelength conversion element 6A from the −Y direction. That is, the wavelength conversion element 6A is provided to the base 91. In addition, the first biasing member 92, the second biasing members 93, the first cover member, and the second cover member are fixed to the base 91. The base 91 is a metal body formed of metal such as aluminum, iron, or stainless steel, and has high thermal conductivity and heat dissipation capability.

As illustrated in FIG. 4, the base 91 includes a first housing portion 911, a second housing portion 912, a first recessed portion 913, a second recessed portion 914, an arrangement portion 915, and a third recessed portion 916, and the portions 911 to 915 are disposed at a first surface 91A facing to the +Y direction in the base 91.

### Configuration of First Housing Portion

The first housing portion 911 houses the light guide 61A. In detail, the light guide 61A is provided to the first housing portion 911 in a state in which a first side surface 611 is exposed. The first housing portion 911 is a groove that linearly extends along the +Z direction and opens in the +Y direction. The first housing portion 911 is disposed at the center of the first surface 91A in the +X direction.

### Configuration of Second Housing Portion

The second housing portion 912 is disposed at the +Z direction side of the first housing portion 911. The second housing portion 912 is a recessed portion that opens in the +Y direction and the +Z direction, and is formed in a rectangular shape when viewed from the +Y direction.

The second housing portion 912 communicates with the first housing portion 911 in which the light guide 61A is housed, and houses an end portion in the +Z direction of the light guide 61A, an angle conversion member 63, and an adhesive 64. The second housing portion 912 is covered in the +Y direction with a first cover member (not illustrated) fixed to the base 91.

### Configuration of First Recessed Portion and Second Recessed Portion

The first recessed portion 913 and the second recessed portion 914 are each a recessed portion extending along the +X direction and straddling the first housing portion 911 extending along the +Z direction, and is recessed in the −Y direction from the first surface 91A. The first recessed portion 913 and the second recessed portion 914 are separate from each other in the +Z direction, and the second recessed portion 914 is disposed at the −Z direction side of the first recessed portion 913. Out of the two second biasing members 93, a second biasing member 93A is fixed to the first recessed portion 913 with screws S1, and a second biasing member 93B is fixed to the second recessed portion 914 with screws S2.

### Configurations of Arrangement Portion and Third Recessed Portion

The arrangement portion 915 is a recessed portion disposed at an end portion in the −Z direction of the first surface 91A and recessed in the −Y direction from the first surface 91A. The first biasing member 92 is disposed at the arrangement portion 915. The arrangement portion 915 is covered in the +Y direction with the second cover member (not illustrated) fixed to the base 91.

The third recessed portion 916 is a recessed portion recessed in the +X direction in the base 91, and opens in each of the −X direction, the +Y direction, and the −Y direction. When the light source unit 5 is fixed to the base 91, a connector 53 of a substrate 51 is disposed in the third recessed portion 916.

### Configurations of First Biasing Member and Second Biasing Members

The first biasing member 92 is provided to the arrangement portion 915 and biases a reflective member 62 described later toward the light guide 61A. The first biasing member 92 can be configured with, for example, a plate spring.

The second biasing members 93 are fixing members that fix the light guide 61A to the base 91. In detail, the second biasing members 93 fix the light guide 61A to the base 91 by being fixed to the base 91 in a state of biasing the light guide 61A from the +Y direction toward the base 91.

In the present embodiment, two second biasing members 93 are provided. One of the two second biasing members 93 is the second biasing member 93A disposed in the first recessed portion 913, and the other is the second biasing member 93B disposed in the second recessed portion 914. The second biasing member 93B is separate in the −Z direction from the second biasing member 93A. In the present embodiment, the second biasing members 93A, 93B are each configured with a plate spring.

### Configuration of Fluorescence Emitting Device

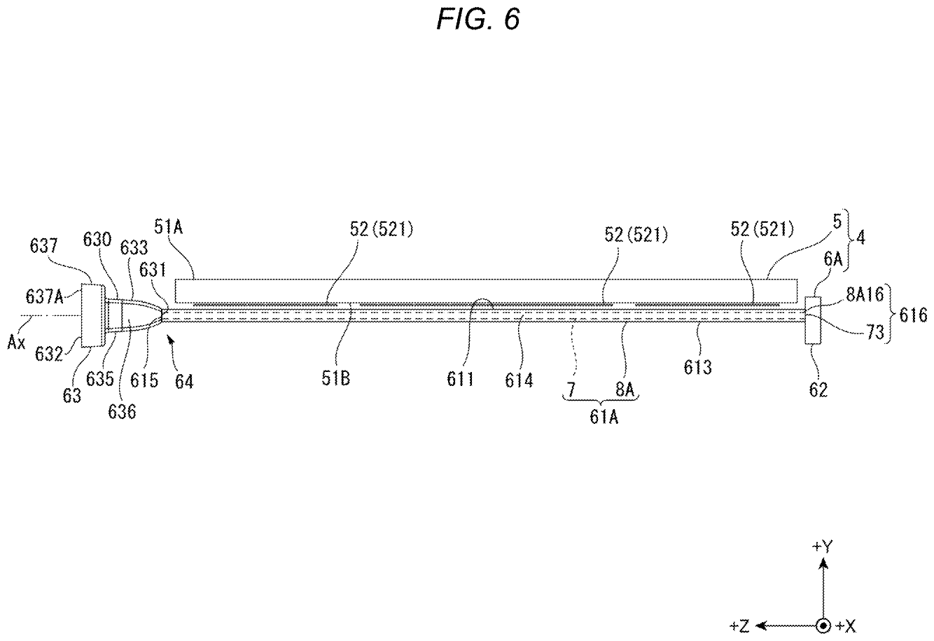

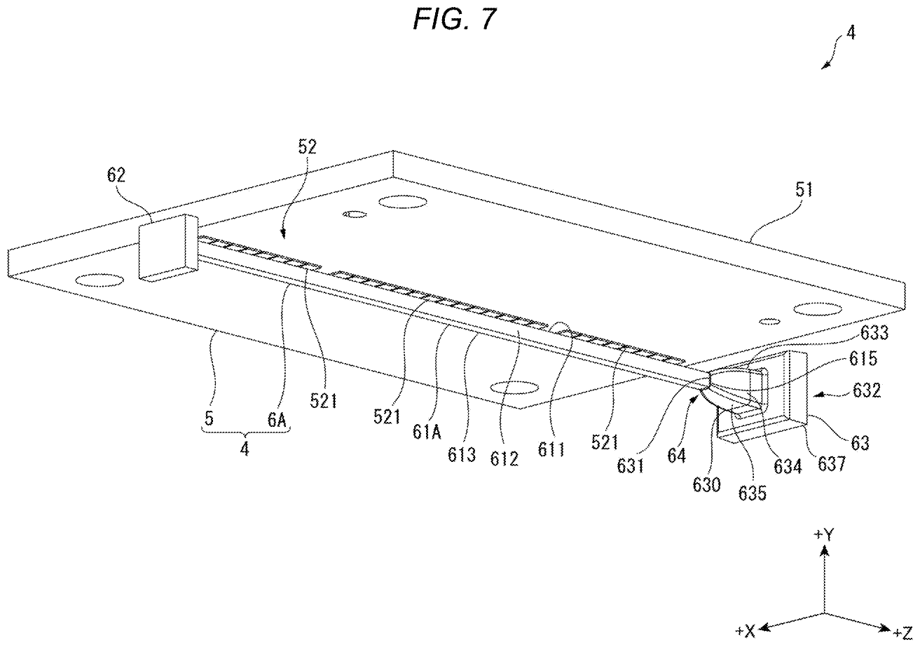

FIG. 6 is a side view showing the fluorescence emitting device 4 viewed from the +X direction. FIG. 7 is a perspective view of the fluorescence emitting device 4 viewed from the −Z direction.

The fluorescence emitting device 4 is housed in the housing 9 and outputs the fluorescence YL. As shown in FIGS. 6 and 7, the fluorescence emitting device 4 includes the light source unit 5 and the wavelength conversion element 6A.

### Configuration of Light Source Unit

The light source unit 5 emits first light to the light guide 61A of the wavelength conversion element 6A. In the present embodiment, the light source unit 5 outputs excitation light that excites a phosphor contained in the light guide 61A to the light guide 61A. The light source unit 5 is disposed at the +Y direction side of the light guide 61A. The light source unit 5 includes the substrate 51, a light source 52 mounted on the substrate 51, and the connector 53.

The substrate 51 is disposed at a side opposite to the base 91 across the light guide 61A to cover the light guide 61A, and is fixed to the base 91. The substrate 51 has a first surface 51A facing to the +Y direction, and a second surface 51B facing to the −Y direction.

The second surface 51B is a surface at an opposite side to the first surface 51A and faces the light guide 61A. The light source 52 and the connector 53 are mounted on the second surface 51B. That is, the second surface 51B supports the light source 52 and the connector 53.

The light source 52 outputs the excitation light in the −Y direction. The light source 52 is configured with at least one light emitting element 521 arranged along the +Z direction, and a light exit surface of the light emitting element 521 faces the first side surface 611 described later of the light guide 61A. That is, the plurality of light emitting elements 521 each output the excitation light to be incident on the first side surface 611. The excitation light output by the light emitting element 521 is light having a first wavelength band of, for example, 400 nm to 480 nm, and a peak wavelength of the excitation light is, for example, 445 nm. The light emitting element 521 is a light emitting diode (LED) in the present embodiment, but may instead be another light emitting element such as a laser diode (LD).

The connector 53 is disposed at a position at the −X direction side of the light source 52 in the second surface 51B. Electric power that allows the light emitting element 521 to emit light is externally supplied to the connector 53.

### Configuration of Wavelength Conversion Element

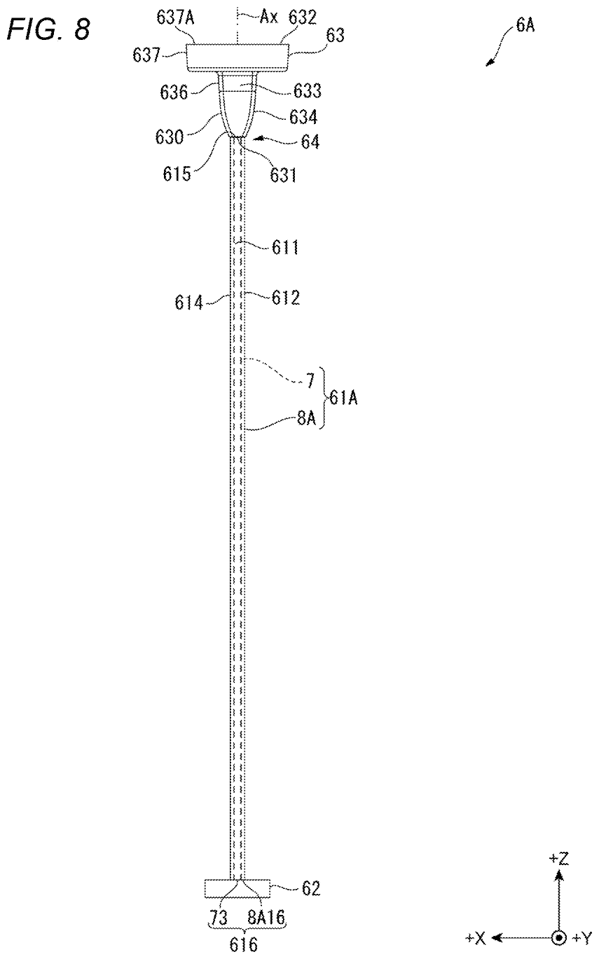

FIG. 8 is a plan view showing the wavelength conversion element 6A viewed from the +Y direction.

The wavelength conversion element 6A has a function of guiding light based on the light emitted from the light source unit 5 to the outside of the light source device 3. In the present embodiment, the wavelength conversion element 6A converts the wavelength of the excitation light output from the light source unit 5 to generate the fluorescence YL, and guides the fluorescence YL to the outside of the light source device 3. That is, the wavelength conversion element 6A is an optical transmission member.

As illustrated in FIGS. 5 to 7, the wavelength conversion element 6A includes the light guide 61A, the reflective member 62, the angle conversion member 63, and the adhesive 64.

### Schematic Configuration of Light Guide

The excitation light is incident on the light guide 61A along the −Y direction from the light emitting elements 521. The light guide 61A converts the incident excitation light into the fluorescence YL having a second wavelength band different from the first wavelength band of the excitation light, and emits the fluorescence in the +Z direction crossing the −Y direction.

As shown in FIGS. 6 to 8, the light guide 61A has the first side surface 611, a second side surface 612, a third side surface 613, a fourth side surface 614, a first end surface 615, and a second end surface 616, and is formed in a substantially quadrangular columnar shape elongated along the +Z direction. Note that the area of the cross section of the light guide 61A perpendicular to the +Z direction is substantially constant along the +Z direction, and is no smaller than 0.25 mm² and no larger than 4.00 mm². In the present embodiment, the cross section of the light guide 61A is a square, 1.00 mm on a side.

The side surfaces 611 to 614 extend along the +Z direction. As shown in FIGS. 6 to 8, the first side surface 611 is an outer surface facing to the +Y direction.

As shown in FIGS. 6 and 7, the first side surface 611 has an incident region which faces the light source 52 and on which the excitation light from the light source 52 is incident.

The second side surface 612 is an outer surface facing to the −X direction as shown in FIGS. 7 and 8, the third side surface 613 is an outer surface facing to the −Y direction as shown in FIGS. 6 and 7, and the fourth side surface 614 is an outer surface facing to the +X direction as shown in FIGS. 6 and 8.

As shown in FIGS. 6 and 8, the first end surface 615 and the second end surface 616 are surfaces located at respective sides opposite to each other in the +Z direction, the first end surface 615 is an outer surface of the light guide 61A and faces to the +Z direction, and the second end surface 616 is an outer surface of the light guide 61A and faces to the −Z direction. The first end surface 615 and the second end surface 616 each cross each of the side surfaces 611 to 614. Each of the first end surface 615 and the second end surface 616 has a square shape as described above.

The reflective member 62 is biased so as to be pressed against the second end surface 616 by the first biasing member 92. The light emitted from the second end surface 616 to the outside of the light guide 61A toward the −Z direction is reflected by the reflective member 62 toward the +Z direction and then enters the light guide 61A from the second end surface 616.

The first end surface 615 is an exit surface from which the fluorescence YL generated in the light guide 61A is emitted in the +Z direction. The angle conversion member 63 is bonded to the first end surface 615 with the adhesive 64.

### Configuration of Angle Conversion Member

The angle conversion member 63 is disposed at the first end surface 615. The angle conversion member 63 is a compound parabolic concentrator (CPC), and is made of a light transmissive material, such as borosilicate glass or a cycloolefin resin, and formed in a substantially truncated rectangular pyramidal shape. As shown in FIGS. 6 to 8, the angle conversion member 63 includes a light passage portion 630 and a flange portion 637.

The light passage portion 630 is a portion of the angle conversion member 63 through which the fluorescence YL incident from the light guide 61A passes. The light passage portion 630 has an end plane of incidence 631, an exit end surface 632, and side surfaces 633, 634, 635, and 636.

The end plane of incidence 631 is disposed so as to face the first end surface 615 and is bonded to the first end surface 615 with the adhesive 64. That is, the end plane of incidence 631 is a surface of the angle conversion member 63 that faces to the −Z direction and faces the first end surface 615. The fluorescence YL output from the first end surface 615 is incident on the end plane of incidence 631.

The exit end surface 632 is a surface at an opposite side to the end plane of incidence 631 and is a surface facing to the +Z direction. The fluorescence YL having entered the angle conversion member 63 from the end plane of incidence 631 is emitted from the exit end surface 632.

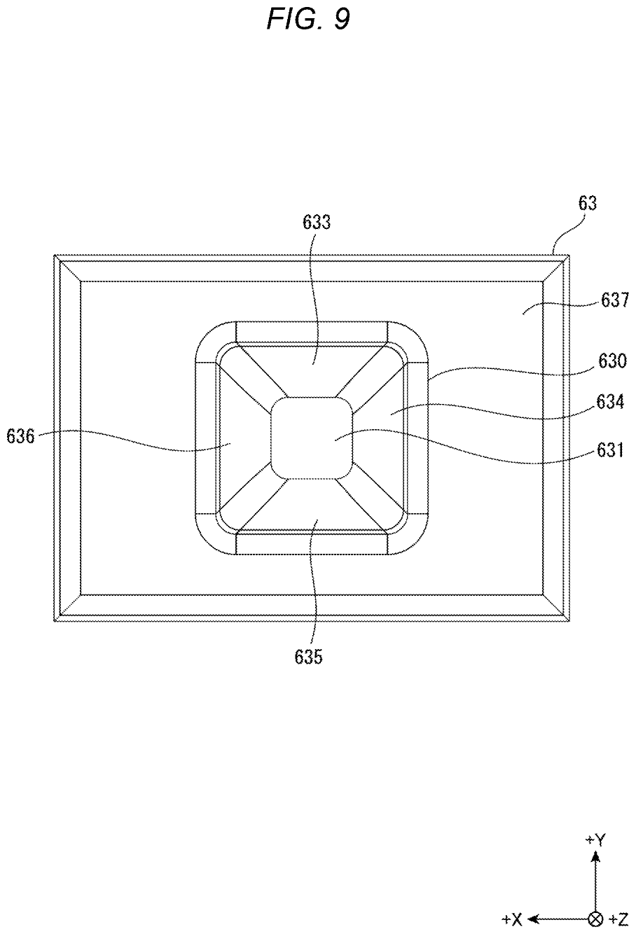

FIG. 9 is a diagram illustrating the angle conversion member 63 viewed from the −Z direction. That is, FIG. 9 is a view of the angle conversion member 63 from the light incident side.

The four side surfaces 633 to 636 are the outer surfaces that cross each of the end plane of incidence 631 and the exit end surface 632 and the outer surfaces extending along the circumferential direction around an optical axis Ax of the angle conversion member 63. Each of the side surfaces 633 to 636 is a parabolic curved surface.

As shown in FIG. 9, the first side surface 633 faces to the +Y direction, and the third side surface 635 faces to the −Y direction. The second side surface 634 faces to the −X direction, and the fourth side surface 636 faces to the +X direction. An inner surface of each of the side surfaces 633 to 636 functions as a reflection surface that reflects, toward the exit end surface 632, the fluorescence YL having entered the angle conversion member 63 via the end plane of incidence 631.

As shown in FIGS. 6 and 8, the cross-sectional area of the light passage portion 630 perpendicular to the optical axis Ax of the angle conversion member 63, that is, the cross-sectional area of the light passage portion 630 perpendicular to the +Z direction increases in a direction from the end plane of incidence 631 toward the exit end surface 632, and the area of the exit end surface 632 is greater than the area of the end plane of incidence 631.

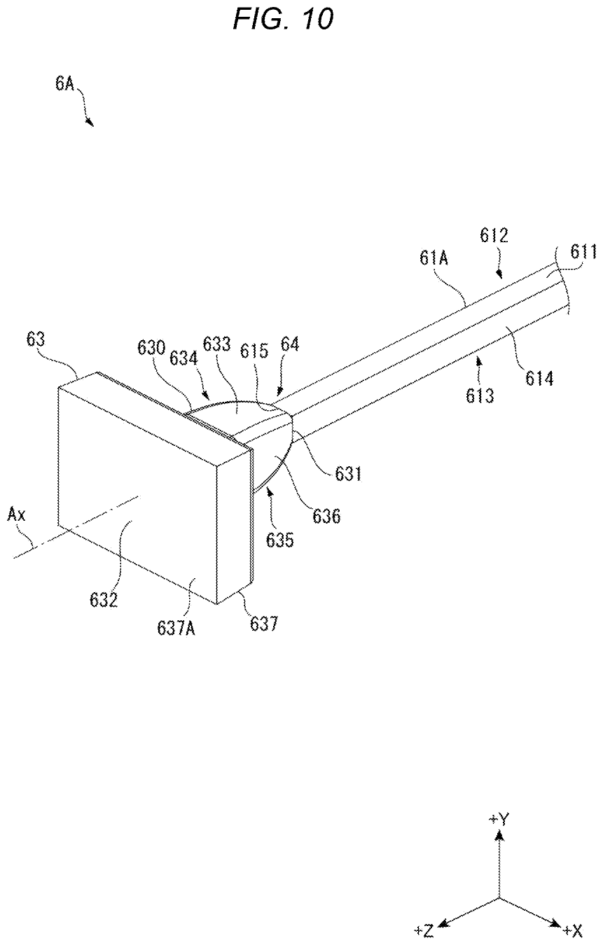

FIG. 10 is a perspective view illustrating the angle conversion member 63 viewed from the +Z direction. That is, FIG. 10 is a perspective view showing the angle conversion member 63 viewed from the light exit side.

The flange portion 637 is a portion projecting from the light passage portion 630 outward in a radial direction centered on the optical axis Ax. The flange portion 637 is disposed at the end portion at the light exit side in the light passage portion 630, and a side surface 637A at the +Z direction side of the flange portion 637 coincides with the exit end surface 632. That is, the flange portion 637 is disposed in a region of the angle conversion member 63 through which the fluorescence YL incident from the end plane of incidence 631 and exiting from the exit end surface 632 does not pass. Specifically, as shown in FIGS. 6 to 10, the flange portion 637 is a portion projecting from the light passage portion 630 in the +X direction and the +Y direction each crossing the optical axis Ax along the +Z direction, and is a portion through which the fluorescence YL incident on the angle conversion member 63 from the light guide 61A does not pass.

### Configuration of Adhesive

As shown in FIGS. 6 and 8, the adhesive 64 bonds the first end surface 615 of the light guide 61A and the end plane of incidence 631 of the angle conversion member 63 to each other. In the present embodiment, the adhesive 64 is disposed in the entire area between the first end surface 615 and the end plane of incidence 631. When the angle conversion member 63 is made of borosilicate glass having a refractive index no lower than 1.50 and no higher than 1.55, a phenyl-based silicone resin adhesive can be adopted as the adhesive 64, and further, a phenyl-based silicone resin adhesive having thermosetting or ultraviolet curing properties can be suitably adopted. An additive may be added to the phenyl-based silicone resin adhesive to appropriately adjust the refractive index of the adhesive 64 as needed. In this case, since the refractive index of the adhesive 64 can be set to approximately 1.5, the difference between the refractive index of the angle conversion member 63 and the refractive index of the adhesive 64 can be reduced, and the fluorescence YL can be easily incident on the angle conversion member 63 from the wavelength conversion element 6A.

### Detailed Configuration of Light Guide

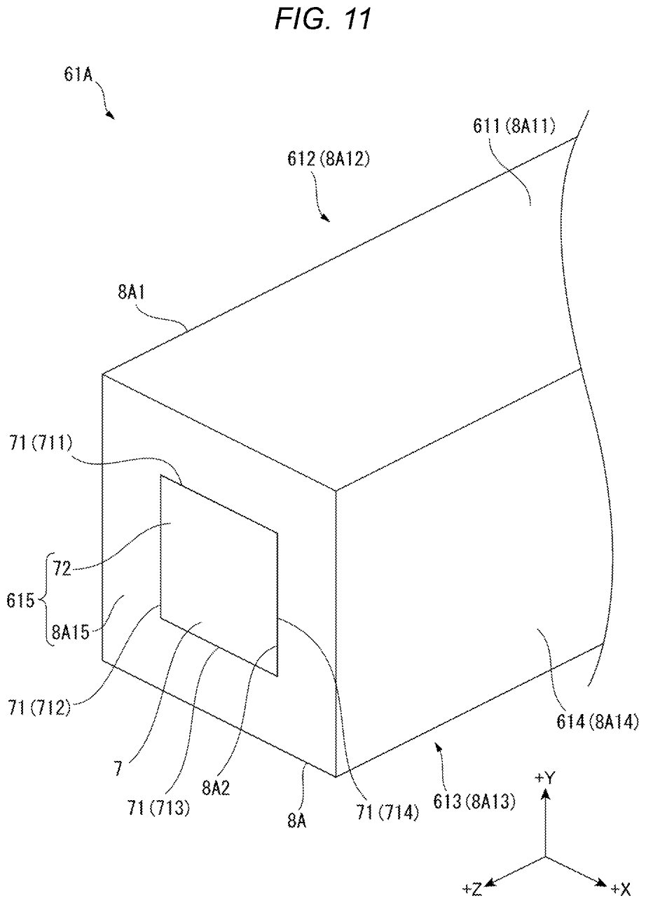

FIG. 11 is a perspective view illustrating the light guide 61A viewed from the +Y direction and the +Z direction.

As shown in FIG. 11, the light guide 61A includes a wavelength conversion member 7 and a light transmissive member 8A, and has a configuration in which the wavelength conversion member 7 is disposed inside the light transmissive member 8A.

### Configuration of Wavelength Conversion Member

The wavelength conversion member 7 converts the wavelength of the excitation light incident from the light emitting elements 521 in the −Y direction to emit the fluorescence YL. As described above, the excitation light corresponds to the first light, and the fluorescence YL corresponds to second light. That is, the wavelength conversion member 7 contains a phosphor that converts the excitation light incident from the light emitting elements 521 into the fluorescence YL having the second wavelength band different from the first wavelength band that the excitation light has. As the phosphor contained in the wavelength conversion member 7, for example, a YAG-based phosphor containing yttrium, aluminum, and garnet can be cited.

As shown in FIG. 11, the wavelength conversion member 7 is configured to have a substantially quadrangular prism shape that has a second end surface 73 shown in FIG. 8 in addition to a side surface 71 and a first end surface 72, and is elongated along the +Z direction. The area of the cross section of the wavelength conversion member 7 orthogonal to the +Z direction is substantially constant in the +Z direction. In the present embodiment, the cross-sectional shape of the wavelength conversion member 7 orthogonal to the +Z direction is a substantially square shape, 0.5 mm on a side.

The side surface 71 is configured with a plurality of partial side surfaces crossing each other in the circumferential direction about the central axis of the wavelength conversion member 7 along the +Z direction. Specifically, the side surface 71 is formed of four partial side surfaces 711 to 714 extending along the +Z direction and crossing each other.

A first partial side surface 711 is an outer surface facing to the +Y direction. The first partial side surface 711 faces the light emitting elements 521 and includes an incident region on which the excitation light is incident from the light emitting elements 521. That is, the excitation light emitted from the light emitting elements 521 is incident on the first partial side surface 711.

A second partial side surface 712 is an outer surface facing to the −X direction, the third partial side surface 713 is an outer surface facing to the −Y direction, and the fourth partial side surface 714 is an outer surface facing to the +X direction.

The first end surface 72 is an outer surface of the wavelength conversion member 7 facing to the +Z direction and crosses the side surface 71. That is, the first end surface 72 is an end surface that crosses the side surface 71 and is disposed at one end in the +Z direction. The first end surface 72 constitutes the first end surface 615 of the light guide 61A. The first end surface 72 is an exit surface from which the wavelength conversion member 7 emits the fluorescence YL in the +Z direction.

As shown in FIGS. 6 and 8, the second end surface 73 is an outer surface of the wavelength conversion member 7 facing to the −Z direction and crosses the side surface 71. That is, the second end surface 73 is an end surface that crosses the side surface 71 and is disposed at the other end in the +Z direction. The second end surface 73 constitutes the second end surface 616 of the light guide 61A.

### Configuration of Light Transmissive Member

The light transmissive member 8A is made of a light transmissive material capable of transmitting the excitation light and the fluorescence YL, and covers the periphery of the wavelength conversion member 7 in the circumferential direction about the axis along the +Z direction. In other words, the light transmissive member 8A is disposed at the side surface 71 along the +Z direction. The refractive index of the light transmissive member 8A is lower than the refractive index of the wavelength conversion member 7.

The light transmissive member 8A has a cylindrical portion 8A1 and an arrangement portion 8A2, and is formed in a cylindrical shape.

The cylindrical portion 8A1 covers substantially the entire side surface 71 of the wavelength conversion member 7. The cylindrical portion 8A1 includes a first side surface 8A11, a second side surface 8A12, a third side surface 8A13, a fourth side surface 8A14, and a first end surface 8A15, and further includes a second end surface 8A16 illustrated in FIGS. 6 and 8.

As illustrated in FIG. 11, the first side surface 8A11 is an outer surface facing to the +Y direction, and constitutes the first side surface 611 of the light guide 61A. That is, the first side surface 611 is located, in the +Y direction, between the light emitting element 521 and the first partial side surface 711 of the wavelength conversion member 7 on which the excitation light is incident. Therefore, the excitation light is incident on the first side surface 8A11 from the light emitting elements 521.

The second side surface 8A12 is an outer surface facing to the −X direction, and constitutes the second side surface 612.

The third side surface 8A13 is an outer surface facing to the −Y direction, and constitutes the third side surface 613.

The fourth side surface 8A14 is an outer surface facing to the +X direction, and constitutes the fourth side surface 614.

The first end surface 8A15 is an outer surface facing to the +Z direction, and constitutes a part of the first end surface 615. That is, the first end surface 8A15 is bonded to the angle conversion member 63 via the adhesive 64.

As illustrated in FIGS. 6 and 8, the second end surface 8A16 is an outer surface facing to the −Z direction and constitutes a part of the second end surface 616. That is, the reflective member 62 is biased to be pressed against the second end surface 8A16.

The arrangement portion 8A2 is disposed inside the cylindrical portion 8A1 and is a space which has a square cross-sectional shape and in which the wavelength conversion member 7 is arranged. That is, the cross-sectional shape of the arrangement portion 8A2 orthogonal to the +Z direction substantially matches the cross-sectional shape of the wavelength conversion member 7 orthogonal to the +Z direction.

As such a light transmissive member 8A, it is preferable to adopt a light transmissive member having an internal transmittance no lower than 80% in at least a part of the visible light region when setting the thickness of the light transmissive member 8A to 10 mm. As the light transmissive member 8A, it is more preferable to adopt a light transmissive member having an internal transmittance no lower than 90%, and it is even more preferable to adopt a light transmissive member having an internal transmittance no lower than 95%.

In the present embodiment, an inner surface of the arrangement portion 8A2 and the side surface 71 of the wavelength conversion member 7 are fixed to each other by bonding with an adhesive (not shown). Specifically, the inner surface of the arrangement portion 8A2 and each of the partial side surfaces 711 to 714 constituting the side surface 71 of the wavelength conversion member 7 are fixed to each other by bonding with an adhesive. In other words, the inner surface of the arrangement portion 8A2 and the side surface 71 of the wavelength conversion member 7 are in contact with each other via the adhesive.

However, this is not a limitation, and a part of the inner surface of the arrangement portion 8A2 and a part of the side surface 71 of the wavelength conversion member 7 may be fixed to each other with an adhesive. In addition, as long as the wavelength conversion member 7 can be held in the arrangement portion 8A2, at least a part of the inner surface of the arrangement portion 8A2 and at least a part of the side surface 71 of the wavelength conversion member 7 may be in contact with each other without an adhesive.

Examples of the adhesive for fixing the inner surface of the arrangement portion 8A2 and the side surface 71 of the wavelength conversion member 7 include an epoxy-based adhesive, an acrylate-based adhesive, a silicone-based adhesive, and a polyurethane-based adhesive. Examples of the adhesive include an ultraviolet curable adhesive and a thermosetting adhesive. The refractive index of the adhesive is preferably smaller than the refractive index of the wavelength conversion member 7.

In such a light transmissive member 8A, the dimensional ratio of the thickness of the light transmissive member 8A covering one side of the cross section of the wavelength conversion member 7 orthogonal to the +Z direction to the length of the one side is no lower than 0.5. That is, the light transmissive member 8A is not a thin film such as a dielectric multilayer film formed on the side surface 71 of the wavelength conversion member 7.

In the present embodiment, the cross section of the wavelength conversion member 7 is 0.5 mm on a side. Specifically, the length of one side along the +Y direction in the cross section of the wavelength conversion member 7 is 0.5 mm. In contrast, the dimension between the first side surface 8A11 and the inner surface of the arrangement portion 8A2 facing to the −Y direction is no smaller than 0.25 mm, and the dimension between the third side surface 8A13 and the inner surface of the arrangement portion 8A2 facing to the +Y direction is no smaller than 0.25 mm.

Similarly, the length of one side along the +X direction in the cross section of the wavelength conversion member 7 is 0.5 mm. In contrast, the dimension between the second side surface 8A12 and the inner surface of the arrangement portion 8A2 facing to the −X direction is no smaller than 0.25 mm, and the dimension between the fourth side surface 8A14 and the inner surface of the arrangement portion 8A2 facing to the +X direction is no smaller than 0.25 mm.

With such dimensional ratios, the bonding area between the light guide 61A and the angle conversion member 63 can be increased to four or more times the bonding area between the wavelength conversion member 7 and the angle conversion member 63.

### Trajectory of Excitation Light and Fluorescence in Wavelength Conversion Element

The excitation light, which is the first light emitted from the light emitting elements 521 in the −Y direction, enters the light transmissive member 8A from the first side surface 611 of the light guide 61A defined by the first side surface 8A11. The excitation light that has entered the light transmissive member 8A travels through the light transmissive member 8A and then enters the wavelength conversion member 7 via the first partial side surface 711 of the wavelength conversion member 7. The excitation light having entered the wavelength conversion member 7 is subjected to the wavelength conversion into the fluorescence YL as the second light by the phosphor contained in the wavelength conversion member 7.

The fluorescence YL is emitted radially from the phosphor. A part of the fluorescence YL travels in the +Z direction while being internally reflected by the side surface 71 of the wavelength conversion member 7, and is then emitted in the +Z direction from the first end surface 72 of the wavelength conversion member 7, and is incident on the angle conversion member 63. Another part of the fluorescence YL travels in the −Z direction while being internally reflected by the side surface 71 of the wavelength conversion member 7, and is then emitted in the −Z direction from the second end surface 73 of the wavelength conversion member 7. The fluorescence YL emitted from the second end surface 73 is reflected by the reflective member 62, then enters the wavelength conversion member 7 from the second end surface 73, travels in the +Z direction, and enters the angle conversion member 63 from the first end surface 72. A part of the excitation light that has not been converted into the fluorescence YL similarly travels in the wavelength conversion member 7, and is converted into the fluorescence YL by being incident on the phosphor in the wavelength conversion member 7.

Here, out of the excitation light and the fluorescence YL traveling in the wavelength conversion member 7, a part of the excitation light and a part of the fluorescence YL enter the light transmissive member 8A from the side surface 71 without being internally reflected by the side surface 71 of the wavelength conversion member 7. A part of such excitation light and fluorescence YL is internally reflected by the side surfaces 8A11 to 8A14, which are the outer surfaces of the light transmissive member 8A, and reenters the wavelength conversion member 7, another part thereof enters the angle conversion member 63 from the first end surface 8A15 of the light transmissive member 8A, and a still another part thereof is emitted from the second end surface 8A16 to the reflective member 62 and travels through the light transmissive member 8A via the reflective member 62.

Light emitted from the side surfaces 8A11 to 8A14 of the light transmissive member 8A to the outside of the light guide 61A may be generated in some cases. Such light is reflected by members around the light guide 61A and reenters the light transmissive member 8A. The members around the light guide 61A include inner surfaces of the first housing portion 911 of the base 91.

As described above, the excitation light incident on the light guide 61A is converted into the fluorescence YL by the wavelength conversion member 7, is emitted mainly from the first end surface 72 in the +Z direction, and is then incident on the angle conversion member 63. There is also fluorescence YL emitted from the first end surface 8A15 of the light transmissive member 8A. However, the amount of the fluorescence YL emitted from the first end surface 8A15 is little compared to the amount of the fluorescence YL emitted from the first end surface 72.

While the fluorescence YL having entered the angle conversion member 63 travels inside the angle conversion member 63, the traveling direction of the fluorescence YL changes so as to be closer to a direction parallel to the optical axis Ax of the angle conversion member 63 every time the fluorescence YL is totally reflected by inner sides of the side surfaces 633 to 636. In this manner, the angle conversion member 63 converts an exit angle distribution of the fluorescence YL emitted from the first end surface 615 of the wavelength conversion element 6A. Specifically, the angle conversion member 63 makes the maximum exit angle of the fluorescence YL at the exit end surface 632 smaller than the maximum incident angle of the fluorescence YL at the end plane of incidence 631.

In general, since the etendue of light that is defined by the product of the area of a light exit region and the solid angle (maximum exit angle) of the light is preserved, the etendue of the fluorescence YL is preserved before and after the fluorescence YL is transmitted through the angle conversion member 63. As described above, the area of the exit end surface 632 is greater than the area of the end plane of incidence 631. Therefore, from the viewpoint of the preservation of the etendue, the angle conversion member 63 can make the maximum exit angle of the fluorescence YL at the exit end surface 632 smaller than the maximum incident angle of the fluorescence YL incident on the end plane of incidence 631.

### Material of Light Transmissive Member

The material of the light transmissive member 8A will hereinafter be examined.

The present discloser simulated the etendue of the wavelength conversion element 6A in which one of the light transmissive materials shown in Table 1 below was used as the light transmissive material constituting the light transmissive member 8A.

In Table 1, “BK7” is borosilicate crown glass. “PYREX (registered trademark)” is a registered trademark of Corning Incorporated and is a kind of low-expansion borosilicate glass. “Water” is pure water. “S-LAH66” is an optical glass of OHARA INC. “YAG” is the same material as a base material of the wavelength conversion member 7 and does not contain a phosphor. In “COMPARATIVE EXAMPLE”, the wavelength conversion member 7 is configured to be the same in size as the wavelength conversion element 6A without providing the light transmissive member 8A.

TABLE 1

| | REFRACTIVE | ETENDUE |
|---|---|---|
| MATERIAL | INDEX | (/Sr · mm²) |
| BK7 | 1.51 | 6.2 |
| PYREX (registered | 1.47 | 6.5 |
| trademark) | | |
| WATER | 1.33 | 6.5 |
| S-LAH66 | 1.77 | 7.5 |
| YAG | 1.83 | 9.4 |
| COMPARATIVE EXAMPLE | 1.83 | 9.0 |

As shown in Table 1, the etendue of the wavelength conversion element 6A including the light transmissive member 8A made of YAG having a refractive index equivalent to that of COMPARATIVE EXAMPLE was larger than the etendue of COMPARATIVE EXAMPLE. Meanwhile, the etendue of the wavelength conversion element 6A including the light transmissive member 8A made of each of “BK7”, “PYREX”, “WATER”, and “S-LAH66” having a refractive index smaller than the refractive index of COMPARATIVE EXAMPLE was smaller than the etendue of COMPARATIVE EXAMPLE.

Therefore, it was found that, for example, “BK7”, “PYREX”, “WATER”, and “S-LAH66” can be suitably used as the material of the light transmissive member 8A.

As shown by such simulation results, by adopting the light transmissive member 8A formed of a light transmissive material having a refractive index smaller than the refractive index of the wavelength conversion member 7, the increase in etendue of the wavelength conversion element 6A is suppressed compared to COMPARATIVE EXAMPLE, and the separation of one of the light guide 61A and the angle conversion member 63 from the other thereof in the wavelength conversion element 6A is suppressed.

### Advantages of First Embodiment

The projector 1 according to the present embodiment described above provides the following advantages.

The projector 1 includes the light source device 3, the light modulation devices 27, and the projection optical device 29. The light modulation devices 27 modulate the light containing the fluorescence YL emitted from the light source device 3. The fluorescence YL corresponds to the second light. The projection optical device 29 projects the light modulated by the light modulation devices 27.

The light source device 3 includes the light emitting elements 521 and the wavelength conversion element 6A. The light emitting elements 521 emit the excitation light to the first side surface 611, which is a part of the side surface of the wavelength conversion element 6A. The excitation light corresponds to the first light.

The wavelength conversion element 6A includes the light guide 61A and the angle conversion member 63, and the light guide 61A includes the wavelength conversion member 7 and the light transmissive member 8A.

The wavelength conversion member 7 has the side surface 71 extending in the +Z direction and the first end surface 72 crossing the side surface 71 and disposed at one end in the +Z direction. The wavelength conversion member 7 contains the phosphor that converts the excitation light incident on the first partial side surface 711 of the side surface 71 into the fluorescence YL having the second wavelength band different from the first wavelength band that the excitation light has. The first end surface 72 corresponds to the first surface, and the +Z direction corresponds to a first direction.

The light transmissive member 8A has the first end surface 8A15 disposed at one end in the +Z direction. The light transmissive member 8A is disposed on the side surface 71 along the +Z direction and transmits the excitation light and the fluorescence YL. The first end surface 8A15 corresponds to a second surface.

The angle conversion member 63 is bonded to the first end surface 72 and the first end surface 8A15, and converts the angle of the light emitted from each of the first end surfaces 72, 8A15.

The refractive index of the light transmissive member 8A is smaller than the refractive index of the wavelength conversion member 7.

According to such a configuration, since the angle conversion member 63 is bonded to the first end surface 72 of the wavelength conversion member 7 and the first end surface 8A15 of the light transmissive member 8A, the angle conversion member 63 is bonded to each of the wavelength conversion member 7 and the light transmissive member 8A. According to this configuration, since the bonding area between the angle conversion member 63 and the bonding target of the angle conversion member 63 can be increased compared to when the angle conversion member 63 is bonded only to the wavelength conversion member 7, the fixation by bonding of the angle conversion member 63 can be stabilized.

Here, when the outer diameter of the wavelength conversion member 7 is increased, although the bonding area between the angle conversion member 63 and the wavelength conversion member 7 can be increased, the etendue is increased as described above. In contrast, since the angle conversion member 63 is bonded to each of the wavelength conversion member 7 and the light transmissive member 8A, the fixation by bonding of the wavelength conversion member 7 and the angle conversion member 63 can be stabilized without increasing the outer diameter of the wavelength conversion member 7, that is, the cross-sectional area of the wavelength conversion member 7 orthogonal to the +Z direction. Since the fluorescence YL obtained by performing the wavelength conversion on the excitation light is mainly emitted from the wavelength conversion member 7, an increase in etendue can be suppressed.

Therefore, the separation of the angle conversion member 63 from the wavelength conversion member 7 can be suppressed, and in addition, an increase in etendue can be suppressed.

In addition, since the refractive index of the light transmissive member 8A is smaller than the refractive index of the wavelength conversion member 7, it is possible to make it easy to cause the excitation light from the light transmissive member 8A to enter the inside of the wavelength conversion member 7. The light large in incident angle traveling from the wavelength conversion member 7 toward the light transmissive member 8A is internally reflected inside the wavelength conversion member 7. Unlike the reflection by a metal film or the like, the internal reflection does not absorb the light. Therefore, it is possible to make it easy to perform the wavelength conversion into the fluorescence YL on the excitation light incident on the wavelength conversion member 7 by the phosphor in the wavelength conversion member 7. When the difference between the refractive index of the light transmissive member 8A and the refractive index of the wavelength conversion member 7 is large, the excitation light and the fluorescence YL having entered the wavelength conversion member 7 can be prevented from entering the light transmissive member 8A from the side surface 71 of the wavelength conversion member 7.

Further, by the light transmissive member 8A transmitting the light, absorption of the excitation light and the fluorescence YL in the light transmissive member 8A can be suppressed. Therefore, it is possible to suppress a decrease in the amount of the fluorescence YL emitted from the angle conversion member 63, and in addition, it is possible to suppress heat generation due to the absorption of the light.

In the wavelength conversion element 6A, the wavelength conversion member 7 and the light transmissive member 8A are in contact with each other.

According to such a configuration, an air layer can be prevented from being interposed between the wavelength conversion member 7 and the light transmissive member 8A. Therefore, the excitation light can be easily incident on the wavelength conversion member 7 from the light transmissive member 8A, and n addition, the excitation light can be prevented from being incident on the light transmissive member 8A from the wavelength conversion member 7.

In the wavelength conversion element 6A, the light transmissive member 8A is formed like a cylinder in which the arrangement portion 8A2 where the wavelength conversion member 7 is arranged is disposed.

According to such a configuration, the light transmissive member 8A can be disposed on the periphery of the wavelength conversion member 7 by disposing the wavelength conversion member 7 in the arrangement portion 8A2. Therefore, since the light transmissive member 8A can be easily attached to the wavelength conversion member 7, the wavelength conversion element 6A can be easily assembled. Since the light transmissive member 8A covers the wavelength conversion member 7 in the circumferential direction about the axis along the +Z direction, the wavelength conversion member 7 and the light transmissive member 8A can be stably bonded to the angle conversion member 63.

In the wavelength conversion element 6A, the wavelength conversion member 7 and the light transmissive member 8A are fixed to each other the adhesive containing an adhesive material.

According to such a configuration, the wavelength conversion member 7 and the light transmissive member 8A can be integrated with each other.

In the light source device 3, the light transmissive member 8A covers, in the +Y direction, the first partial side surface 711 of the wavelength conversion member 7 on which the excitation light is incident. That is, the light transmissive member 8A is disposed between the light emitting elements 521 and the wavelength conversion member 7 in the −Y direction in which the excitation light is emitted from the light emitting elements 521.

According to such a configuration, since the excitation light emitted from the light emitting elements 521 enters the wavelength conversion member 7 via the light transmissive member 8A, it is possible not to prevent the excitation light from entering the wavelength conversion member 7.

### Second Embodiment

Then, a second embodiment of the present disclosure will be described.

A projector according to the present embodiment has substantially the same configuration as that of the projector 1 according to the first embodiment, but is different in area of the light transmissive member which covers the wavelength conversion member. Note that in the following description, the same or substantially the same portions as the portions having already been described are denoted by the same reference numerals, and the description thereof will be omitted.

### Schematic Configurations of Projector and Light Source Device

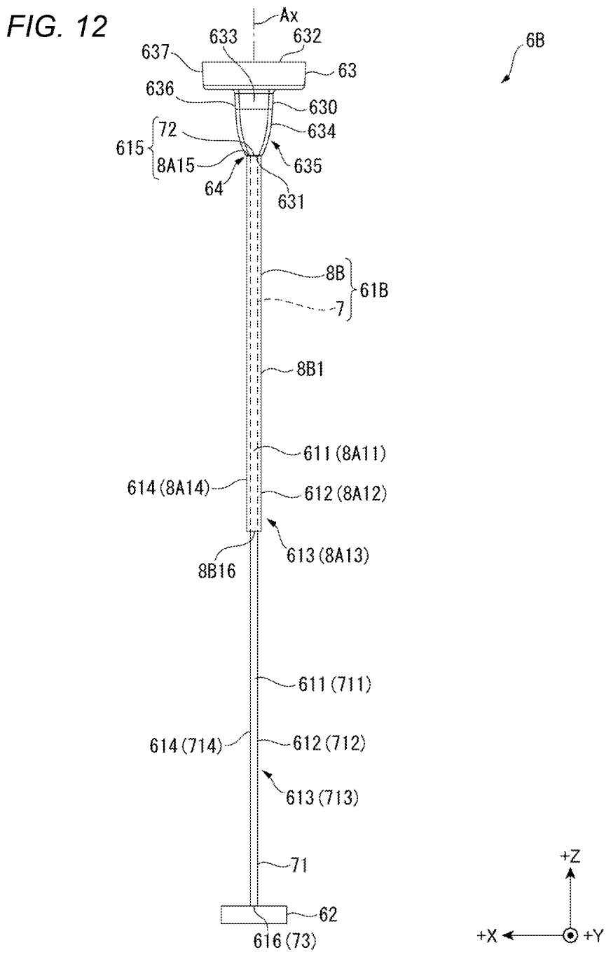

FIG. 12 is a plan view showing a wavelength conversion element 6B provided to the light source device of the projector according to the present embodiment. Specifically, FIG. 12 is a plan view from the +Y direction of the wavelength conversion element 6B in which a coverage factor with a light transmissive member 8B is 50%.

The projector according to the present embodiment has substantially the same configuration and function as those of the projector 1 according to the first embodiment except that the wavelength conversion element 6A is replaced with the wavelength conversion element 6B shown in FIG. 12. That is, the light source device according to the present embodiment includes substantially the same configuration and function as those of the light source device 3 according to the first embodiment except that the wavelength conversion element 6B is provided instead of the wavelength conversion element 6A.

The wavelength conversion element 6B has substantially the same configuration and function as those of the wavelength conversion element 6A according to the first embodiment except that the wavelength conversion element 6B includes a light guide 61B instead of the light guide 61A. That is, the wavelength conversion element 6B includes the light guide 61B, the reflective member 62, the angle conversion member 63, and the adhesive 64.

The light guide 61B has substantially the same configuration and function as those of the light guide 61A according to the first embodiment except that the light guide 61B includes a light transmissive member 8B instead of the light transmissive member 8A. That is, the light guide 61B includes the wavelength conversion member 7 and the light transmissive member 8B.

The light transmissive member 8B has substantially the same configuration and function as those of the light transmissive member 8A except that the dimension along the +Z direction is different. In other words, the light transmissive member 8B is different from the light transmissive member 8A in the coverage factor of covering the side surface 71 of the wavelength conversion member 7. Specifically, the light transmissive member 8A covers substantially the entire side surface 71 of the wavelength conversion member 7, whereas the light transmissive member 8B covers a part in the +Z direction of the side surface 71 with respect to the first end surface 615 of the light guide 61B.

Specifically, the light transmissive member 8B includes a cylindrical portion 8B1 and the arrangement portion 8A2 disposed inside the cylindrical portion 8B1, and is formed in a cylindrical shape.

Similarly to the cylindrical portion 8A1, the cylindrical portion 8B1 has the first side surface 8A11, the second side surface 8A12, the third side surface 8A13, the fourth side surface 8A14, the first end surface 8A15, and a second end surface 8B16.

The second end surface 8B16 is an outer surface facing to the −Z direction similarly to the second end surface 8A16. However, the second end surface 8B16 does not constitute the second end surface 616 of the light guide 61B, but is located at the +Z direction side of the second end surface 616.

The first end surface 8A15 of the light transmissive member 8B constitutes a part of the first end surface 615 of the light guide 61B.

### Relationship Between Coverage Factor of Light Transmissive Member and Etendue

A relationship between the coverage factor of the light transmissive member 8B and the etendue will hereinafter be examined.

The present discloser calculated by simulation the etendue of the wavelength conversion element 6B according to the coverage factor of the wavelength conversion member 7 with the light transmissive member 8B with respect to the first end surface 8A15. The simulation results are shown in Table 2 below.

In Table 2 below, “COMPARATIVE EXAMPLE” is the same as “COMPARATIVE EXAMPLE” described above.

The coverage factor is defined as 100% when the entire side surface 71 of the wavelength conversion member 7 is covered with the light transmissive member 8B, and represents a ratio at which the side surface 71 are covered with the light transmissive member 8B with respect to the first end surface 615 of the light guide 61B. For example, the coverage factor of 30% represents a state in which the light transmissive member 8B covers the wavelength conversion member 7 from the first end surface 615 to a position corresponding to 30% of the dimension of the wavelength conversion member 7 in the +Z direction.

TABLE 2

| COVERAGE | LENGTH (mm) OF LIGHT | ETENDUE |
|---|---|---|
| FACTOR | TRANSMISSIVE MEMBER | (/Sr · mm²) |
| 100% | 55.00 | 6.5 |
| 75% | 41.25 | 7.1 |
| 50% | 27.50 | 5.9 |
| 25% | 13.75 | 6.5 |
| 10% | 5.5 | 7.1 |
| 0% | 0 | 4.6 |
| COMPARATIVE | 55.00 | 9.0 |
| EXAMPLE | | |

As shown in Table 2, as long as the coverage factor of the light transmissive member 8B exceeded 0%, the etendue of the wavelength conversion element 6B was smaller than the etendue of COMPARATIVE EXAMPLE described above. Thus, by adopting the light transmissive member 8B having a coverage factor of more than 0% in the wavelength conversion element 6B, the separation of one of the wavelength conversion member 7 and the angle conversion member 63 from the t other thereof is suppressed while reducing the etendue similarly to the wavelength conversion element 6A in which the light transmissive member 8A having a coverage factor of 100% is adopted.

Since the wavelength conversion element having a coverage factor of 0% does not include the light transmissive members 8A, 8B, the bonding area between the light guide and the angle conversion member 63 is small although the etendue is smaller than the etendue of COMPARATIVE EXAMPLE. Therefore, it is difficult to sufficiently suppress the separation of one of the wavelength conversion member 7 and the angle conversion member 63 from the other thereof.

The projector according to the present embodiment described hereinabove provides substantially the same advantages as those of the projector 1 according to the first embodiment.

### Third Embodiment

A third embodiment of the present disclosure will be described below.

A projector according to the present embodiment has substantially the same configuration as that of the projector according to the first embodiment, but is different therefrom in that the light transmissive member is formed of a plate-shaped member. Note that in the following description, the same or substantially the same portions as the portions having already been described are denoted by the same reference numerals, and the description thereof will be omitted.

### Schematic Configurations of Projector and Light Source Device

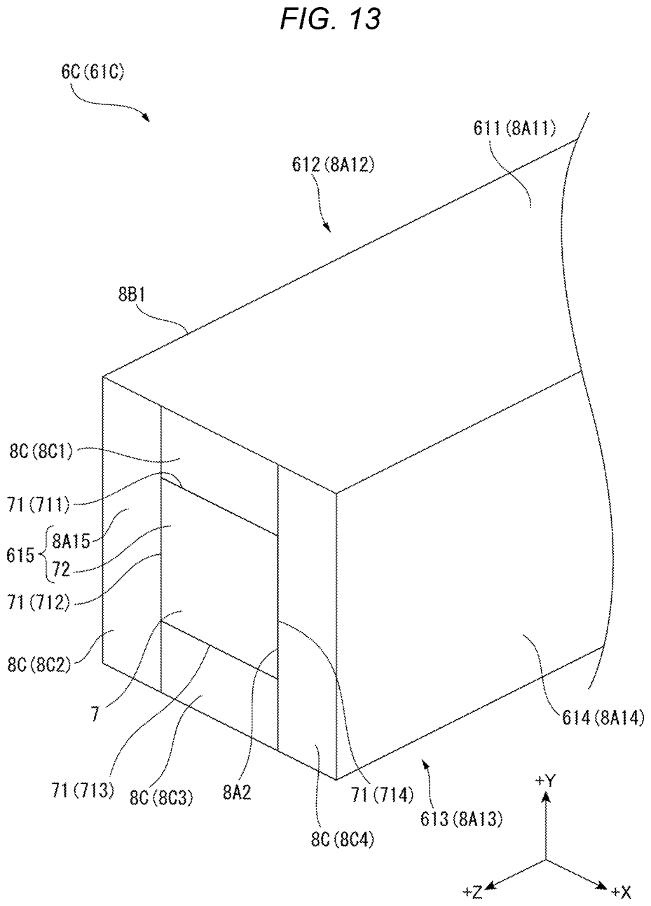

FIG. 13 is a perspective view of a light guide 61C provided to the light source device of the projector according to the present embodiment viewed from the +Z direction.

The projector according to the present embodiment has substantially the same configuration and function as those of the projector 1 according to the first embodiment except that the wavelength conversion element 6A is replaced with the wavelength conversion element 6C shown in FIG. 13. That is, the light source device according to the present embodiment includes substantially the same configuration and function as those of the light source device 3 according to the first embodiment except that the wavelength conversion element 6C is provided instead of the wavelength conversion element 6A.

The wavelength conversion element 6C has substantially the same configuration and function as those of the wavelength conversion element 6A according to the first embodiment except that the wavelength conversion element 6C includes the light guide 61C instead of the light guide 61A. That is, the wavelength conversion element 6C includes the light guide 61C, the reflective member 62, the angle conversion member 63, and the adhesive 64.

The light guide 61C has substantially the same configuration and function as those of the light guide 61A according to the first embodiment except that the light guide 61C includes a light transmissive member 8C instead of the light transmissive member 8A. That is, the light guide 61C includes the wavelength conversion member 7 and the light transmissive member 8C.

Here, the light transmissive member 8A is formed in a frame shape covering the wavelength conversion member 7. In contrast, the light transmissive member 8C is configured such that plate-shaped light transmissive members 8C1 to 8C4 provided corresponding to the respective partial side surfaces 711 to 714 of the wavelength conversion member 7 are joined to each other with an adhesive or the like. That is, the light transmissive member 8C includes a first light transmissive member 8C1, a second light transmissive member 8C2, a third light transmissive member 8C3, and a fourth light transmissive member 8C4, and covers the side surface 71 of the wavelength conversion member 7 in the circumferential direction about the central axis of the wavelength conversion member 7 along the +Z direction.

The first light transmissive member 8C1 is bonded to the first partial side surface 711 and covers the first partial side surface 711 in the +Y direction. The excitation light from the light emitting elements 521 enters the first light transmissive member 8C1. The ratio of the dimension along the +Y direction of the first light transmissive member 8C1 to the dimension along the +Y direction of the wavelength conversion member 7 is no lower than 0.5.

The third light transmissive member 8C3 is bonded to the third partial side surface 713 and covers the third partial side surface 713 in the −Y direction. The ratio of the dimension along the +Y direction of the third light transmissive member 8C3 to the dimension along the +Y direction of the wavelength conversion member 7 is no lower than 0.5.

The second light transmissive member 8C2 is bonded to the second partial side surface 712 to cover the second partial side surface 712 in the −X direction, and in addition, covers surfaces facing to the −X direction of the first light transmissive member 8C1 and the third light transmissive member 8C3. The ratio of the dimension along the +X direction of the second light transmissive member 8C2 to the dimension along the +X direction of the wavelength conversion member 7 is no lower than 0.5.

The fourth light transmissive member 8C4 is bonded to the fourth partial side surface 714, covers the fourth partial side surface 714 in the +X direction, and in addition, covers surfaces facing to the +X direction of the first light transmissive member 8C1 and the third light transmissive member 8C3. The ratio of the dimension along the +X direction of the fourth light transmissive member 8C4 to the dimension along the +X direction of the wavelength conversion member 7 is no lower than 0.5.

Such light transmissive members 8C1 to 8C4 are made of, for example, substantially the same material as the material of the light transmissive member 8A shown in the first embodiment.

An end surface in the +Z direction of each of the light transmissive members 8C1 to 8C4 constitutes the first end surface 615 facing to the +Z direction of the light guide 61C, and is bonded to the angle conversion member 63.

Similarly to the light transmissive member 8B shown in the second embodiment, an end surface at the −Z direction side of each of the light transmissive members 8C1 to 804 may be located at the −Z direction side of the second end surface 73 of the wavelength conversion member 7. That is, the coverage factor of each of the light transmissive members 8C1 to 804 may be less than 100% as long as the coverage factor exceeds 0%.

The light transmissive member 8C sufficiently includes at least one of the light transmissive members 8C1 to 8C4. For example, the light transmissive member 8C is not required to include the light transmissive member 8C located at the −Y direction side of the wavelength conversion member 7. In this case, since the third partial side surface 713 of the side surface 71 of the wavelength conversion member 7 is exposed in the −Y direction, the third partial side surface 713 can be used as a heat dissipation surface that dissipate the heat of the wavelength conversion member 7 to the first housing portion 911.

Further, the light transmissive members 8C1 to 8C4 may be configured as members having the same shape by forming the light transmissive members 8C1 to 8C4 to have, for example, rectangular or trapezoidal cross-sectional shapes.

### Advantages of Third Embodiment

The projector according to the present embodiment provides substantially the same advantages as those of the projector 1 according to the first embodiment and the projector according to the second embodiment, and in addition, provides the following advantages.

In the wavelength conversion element 6C, the side surface 71 includes the plurality of partial side surfaces 711 to 714 extending along the +Z direction and crossing each other. The light transmissive member 8C is formed in a plate shape disposed so as to correspond to at least one of the plurality of partial side surfaces 711 to 714.

Specifically, the light transmissive member 8C includes the first light transmissive member 8C1, the second light transmissive member 8C2, the third light transmissive member 8C3, and the fourth light transmissive member 8C4 each configured to have the plate shape, and the first light transmissive member 8C1 is disposed so as to correspond to the first partial side surface 711, and the second light transmissive member 8C2 is disposed so as to correspond to the second partial side surface 712. The third light transmissive member 8C3 is disposed so as to correspond to the third partial side surface 713, and the fourth light transmissive member 804 is disposed so as to correspond to the fourth partial side surface 714.

According to such a configuration, the light transmissive member 8C can be easily attached to the wavelength conversion member 7. Therefore, the wavelength conversion element 6C can be easily assembled.

In the wavelength conversion element 6C, the light transmissive member 8C covers the side surface 71 of the wavelength conversion member 7 in the circumferential direction about the axis along the +Z direction. Specifically, the light transmissive member 8C covers the side surface 71 of the wavelength conversion member 7 in the circumferential direction about the central axis of the wavelength conversion member 7 along the +Z direction.

According to such a configuration, the light transmissive member 8C covers the entire side surface 71 of the wavelength conversion member 7 in the circumferential direction described above. According to this configuration, the contact area between the light transmissive member 8C and the angle conversion member 63 can be increased compared to when the light transmissive member is disposed only on one of the partial side surfaces 711 to 714. Therefore, the wavelength conversion member 7 and the light transmissive member 8C can be stably bonded to the angle conversion member 63.

### Fourth Embodiment

Then, a fourth embodiment of the present disclosure will be described.

A projector according to the present embodiment has substantially the same configuration as that of the projector 1 according to the first embodiment, but is different therefrom in that a liquid is adopted as a light transmissive material constituting the light transmissive member. Note that in the following description, the same or substantially the same portions as the portions having already been described are denoted by the same reference numerals, and the description thereof will be omitted.

### Schematic Configurations of Projector and Light Source Device

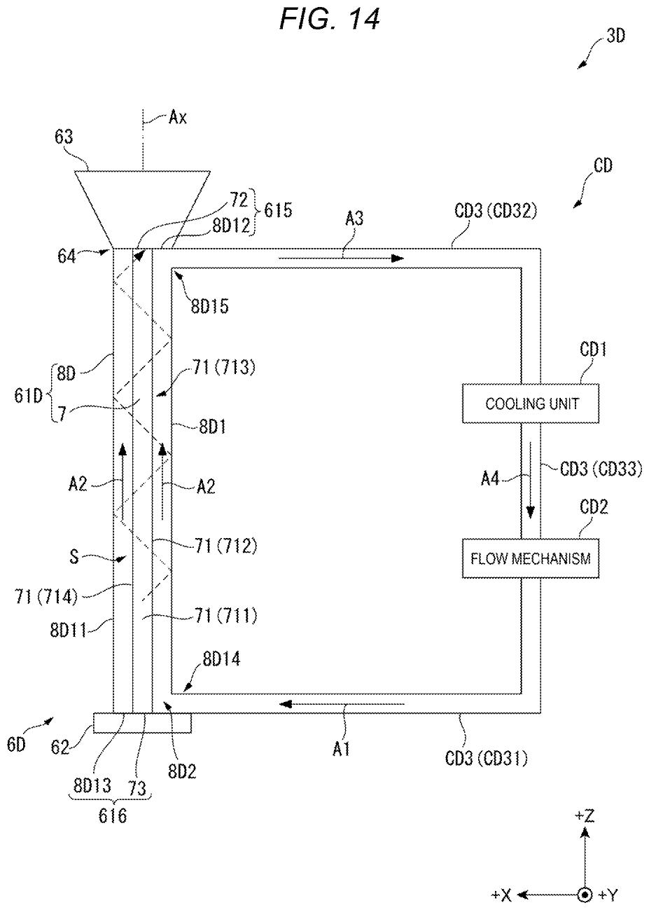

FIG. 14 is a schematic diagram showing a light guide 61D and a circulation device CD provided to the light source device of the projector according to the present embodiment.

The projector according to the present embodiment has substantially the same configuration and function as those of the projector 1 according to the first embodiment except that the light source device 3D shown in FIG. 14 is provided instead of the light source device 3. The light source device 3D has substantially the same configuration and function as those of the light source device 3 according to the first embodiment except that a wavelength conversion element 6D and the circulation device CD are provided instead of the wavelength conversion element 6A.

The wavelength conversion element 6D includes substantially the same configuration and function as those of the wavelength conversion element 6A according to the first embodiment except that the wavelength conversion element 6D includes the light guide 61D instead of the light guide 61A. That is, the wavelength conversion element 6D includes the light guide 61D, the reflective member 62, the angle conversion member 63, and the adhesive 64.

The light guide 61D has substantially the same configuration as that of the light guide 61A according to the first embodiment that the light guide 61D includes a light transmissive member 8D instead of the light transmissive member 8A. That is, the light guide 61D includes the wavelength conversion member 7 and the light transmissive member 8D.

The light transmissive member 8D has a frame body 8D1 covering the side surface 71 of the wavelength conversion member 7, and a light transmissive liquid 8D2 disposed between the frame body 8D1 and the side surface 71, and has substantially the same function as the light transmissive member 8A.

The frame body 8D1 is a cylindrical body formed of a light transmissive material such as glass, and houses the wavelength conversion member 7 inside. The frame body has side surfaces 8D11, a first end surface 8D12, a second end surface 8D13, an inflow portion 8D14, and an outflow portion 8D15.

The side surfaces 8D11 extend along the +Z direction and cover, outside the wavelength conversion member 7, each of the partial side surfaces 711 to 714 constituting the side surface 71. That is, the side surfaces 8D11 cover the side surface 71 along the circumferential direction about the central axis of the wavelength conversion member 7 along the +Z direction. The excitation light emitted from the light emitting elements 521 is incident on the side surface facing to the +Y direction out of the side surfaces 8D11. In the present embodiment, since the frame body is formed of a light transmissive material capable of transmitting the excitation light, the side surface facing to the +Y direction out of the side 8D11 surfaces is a light transmissive portion that transmits the excitation light.

In addition, the inflow portion 8D14 and the outflow portion 8D15 are disposed at a side surface facing to the −X direction out of the side surfaces 8D11.

The first end surface 8D12 is an end surface that crosses the side surfaces 8D11 and is disposed at one end in the +Z direction. That is, the first end surface 8D12 is an end surface facing to the +Z direction. The first end surface 8D12 constitutes the first end surface 615 of the light guide 61D joined to the angle conversion member 63 together with the first end surface 72 of the wavelength conversion member 7.

The second end surface 8D13 is an end surface that crosses the side surfaces 8D11 and is disposed at the other end in the +Z direction. That is, the second end surface 8D13 is an end surface facing to the −Z direction. The second end surface 8D13 constitutes the second end surface 616 of the light guide 61D joined to the reflective member 62 together with the second end surface 73 of the wavelength conversion member 7.

A space S filled with the light transmissive liquid 8D2 is provided in such a frame body 8D1.

The inflow portion 8D14 is provided to a portion at the −Z direction side on a side surface facing to the −X direction out of the side surface 71. A pipe CD31 described later of the circulation device CD is coupled to the inflow portion 8D14. The liquid 8D2 flows into the space S via the inflow portion 8D14.

The outflow portion 8D15 is provided to a portion at the +Z direction side on the side surface facing to the −X direction out of the side surface 71. A pipe CD32 described later of the circulation device CD is coupled to the outflow portion 8D15. The liquid 8D2 in the space S is discharged to the pipe CD32 via the outflow portion 8D15.

The light transmissive liquid 8D2 is, for example, water described above, and is in contact with the side surface 71 of the wavelength conversion member 7. The liquid 8D2 transmits the excitation light emitted from the light emitting elements 521 and incident on the frame body 8D1, and in addition, transmits the fluorescence and the excitation light incident from the wavelength conversion member 7. Further, the liquid 8D2 receives heat from the side surface 71 of the wavelength conversion member 7 to cool the wavelength conversion member 7.

### Configuration of Circulation Device

The circulation device CD circulates the liquid 8D2 to cool the wavelength conversion member 7. The circulation device CD includes a cooling unit CD1, a flow mechanism CD2, and pipes CD3.

The cooling unit CD1 is a radiator and cools the liquid 8D2 flowing through the cooling unit CD1. Specifically, the cooling unit CD1 cools the liquid 8D2 by transferring heat received from the liquid 8D2 to a cooling gas circulated by a fan (not illustrated).

The flow mechanism CD2 delivers the liquid 8D2 cooled by the cooling unit CD1 to a space in the frame body 8D1 via the pipe CD31. The flow mechanism CD2 is, for example, a pump.

The pipes CD3 couple the cooling unit CD1, the flow mechanism CD2, and the frame body 8D1 such that the liquid 8D2 can circulate. The pipes CD3 include the first pipe CD31, the second pipe CD32, and a third pipe CD33.

The first pipe CD31 couples the flow mechanism CD2 and the inflow portion 8D14.

The second pipe CD32 couples the outflow portion 8D15 and the cooling unit CD1.

The third pipe CD33 couples the cooling unit CD1 and the flow mechanism CD2.

### Circulation of Liquid

As indicated by a solid arrow A1 in FIG. 14, the liquid 8D2 delivered by the flow mechanism CD2 circulates through the space S in the frame body 8D1 via the first pipe CD31 and the inflow portion 8D14. As indicated by a solid arrow A2, the liquid 8D2 having flowed through the space S flows through the space S in the +Z direction to cool the wavelength conversion member 7. Note that the liquid 8D2 located in the frame body 8D1 functions in substantially the same manner as the light transmissive members 8A, 8B, and 8C described above.

The liquid 8D2 having flowed in the +Z direction through the frame body 8D1 flows into the pipe CD32 via the outflow portion 8D15, and flows to the cooling unit CD1 as indicated by a solid arrow A3. As described above, the liquid 8D2 having flowed through the cooling unit CD1 is cooled by the cooling unit CD1.

The liquid 8D2 cooled by the cooling unit CD1 flows to the flow mechanism CD2 via the pipe CD33 as indicated by a solid arrow A4, and is delivered once again to the pipe CD31.

As described above, by the liquid 8D2 circulating, the wavelength conversion member 7 is effectively cooled.

### Advantages of Fourth Embodiment

The projector according to the present embodiment described hereinabove provides the following advantages in addition to substantially the same advantages provided by the projector 1 according to the first embodiment.

In the wavelength conversion element 6D, the light transmissive member 8D includes the frame body 8D1 covering the side surface 71 of the wavelength conversion member 7, and the light transmissive liquid 8D2 disposed between the frame body 8D1 and the side surface 71 and in contact with the side surface 71.

Here, the wavelength conversion member 7 generates heat when converting the excitation light into the fluorescence YL. When the temperature of the wavelength conversion member rises, the wavelength conversion efficiency from the excitation light to the fluorescence YL decreases.

In contrast, since the light transmissive liquid 8D2 in contact with the wavelength conversion member 7 is provided inside the frame body 8D1, the wavelength conversion member 7 can be cooled by the liquid 8D2. Therefore, a decrease in wavelength conversion efficiency due to the heat can be suppressed.

In the wavelength conversion element 6D, the side surface 71 of the wavelength conversion member 7 includes the first partial side surface 711 on which the excitation light is incident. The frame body 8D1 includes the light transmissive portion which is located at the +Y direction side to which the first partial side surface 711 faces the wavelength conversion member 7, and which transmits the excitation light. That is, the side surface facing to the +Y direction out of the side surfaces 8D11 of the frame body 8D1 made of the light transmissive material is the light transmissive portion that transmits the excitation light.

According to such a configuration, the excitation light can be incident on the wavelength conversion member 7 from the outside of the light transmissive member 8D via the side surface described above as the light transmissive portion. Therefore, it is possible to prevent the liquid 8D2 in the frame body 8D1 from leaking to the outside.

The light source device 3D includes the wavelength conversion element 6D, the light emitting elements 521 that emit the excitation light to the first partial side surface 711 of the wavelength conversion member 7, and the flow mechanism CD2 that circulates the liquid 8D2.

According to such a configuration, since the liquid 8D2 can be circulated in the frame body 8D1 by the flow mechanism CD2, the cooling efficiency of the wavelength conversion member 7 can be improved.

It should be noted that the cooling unit CD1 and the flow mechanism CD2 are sufficiently configurations provided to the projector, and are not required to be configurations provided to the light source device 3D. The cooling unit CD1 may be omitted.

### Modifications of Embodiments

The present disclosure is not limited to each of the embodiments described above, and modifications, improvements, and so on in a range in which the object of the present disclosure can be achieved should fall within the scope of the present disclosure.

In the first and second embodiments described above, the light transmissive members 8A, 8D are configured in a frame shape covering the side surface 71 in the circumferential direction about the central axis of the wavelength conversion member 7 along the +Z direction. However, this is not a limitation, and a part of the side surface 71 may be exposed to the outside of the wavelength conversion element. For example, out of the partial side surfaces 711 to 714 constituting the side surface 71, the partial side surface 713 facing to the −Y direction may be exposed to the outside of the wavelength conversion element. The partial side surface 711 facing to the +Y direction may be exposed to the outside of the wavelength conversion element, and the light transmissive member disposed between the light emitting elements 521 and the wavelength conversion member 7 in the +Y direction may be omitted. The same applies to the wavelength conversion element 6C according to the third embodiment and the wavelength conversion element 6D according to the fourth embodiment.

In each of the embodiments described above, the wavelength conversion member 7 is in contact with the light transmissive members 8A, 8B, 8C, and 8D. However, this is not a limitation, and the wavelength conversion member 7 is not required to be in contact with the light transmissive members 8A, 8B, 8C, and 8D. The wavelength conversion member 7 is not required to be bonded to the light transmissive members 8A, 8B, 8C, and 8D with the adhesive.

In the fourth embodiment described above, the light source device 3D includes the circulation device CD. However, this is not a limitation, and the circulation device CD may be omitted. That is, the liquid 8D2 of the light transmissive member 8D may be present in a state of being encapsulated in the frame body 8D1 and is not required to flow to the outside of the frame body 8D1.

In each of the embodiments described above, it is assumed that the projector includes the three light modulation devices 27R, 27G, and 27B. However, this is not a limitation, and the present disclosure is also applicable to a projector including two or less or four or more light modulation devices.

In each of the embodiments described above, it is assumed that the image projection apparatus 2 includes the optical components arranged in the layout shown in FIG. 1. However, this is not a limitation, the optical components constituting the image projection apparatus 2 are not limited to the above, and the layout of the optical components can be appropriately changed.

In each of the embodiments described above, it is assumed that the light modulation devices 27 each include the transmissive liquid crystal panel having the plane of incidence of light and the light exit surface different from each other. However, this is not a limitation, and the light modulation devices 27 may each include a reflective liquid crystal panel in which the plane of incidence of light and the light exit surface are the same. Further, a light modulation device using any element other than the liquid crystal-based element, such as a device using micromirrors, for example, a digital micromirror device (DMD), may be used as long as the light modulation device is capable of modulating the incident light flux to form an image according to image information.

### SUMMARY OF PRESENT DISCLOSURE

The present disclosure will be summarized below as appendices.

### APPENDIX 1

A wavelength conversion element comprising:
a wavelength conversion member having a side surface extending in a first direction and a first surface crossing the side surface and disposed at one end in the first direction, and containing a phosphor configured to convert first light having a first wavelength band and incident on the side surface into second light having a second wavelength band different from the first wavelength band;
a light transmissive member which has a second surface disposed at one end in the first direction, is disposed at the side surface along the first direction, and is configured to transmit the first light and the second light; and
an angle conversion member bonded to the first surface and the second surface, and configured to convert an angle of light emitted from the first surface and the second surface, wherein
a refractive index of the light transmissive member is smaller r than a refractive index of the wavelength conversion member.

According to such a configuration, since the angle conversion member is bonded to the first surface of the wavelength conversion member and the second surface of the light transmissive member, the angle conversion member is bonded to each of the wavelength conversion member and the light transmissive member. According to this configuration, since the bonding area between the angle conversion member and the bonding target of the angle conversion member can be increased compared to when the angle conversion member is bonded only to the wavelength conversion member, the fixation by bonding of the angle conversion member can be stabilized.

Here, when the outer diameter of the wavelength conversion member is increased, although the bonding area between the angle conversion member and the wavelength conversion member can be increased, the etendue is increased as described above. In contrast, since the angle conversion member is bonded to each of the wavelength conversion member and the light transmissive member, the fixation by bonding between the wavelength conversion member and the angle conversion member can be stabilized without increasing the outer diameter of the wavelength conversion member. Since the second light obtained by converting the wavelength of the first light is mainly emitted from the wavelength conversion member, an increase in etendue can be suppressed.

Therefore, the separation of the angle conversion member from the wavelength conversion member can be suppressed, and in addition, an increase in etendue can be suppressed.

Since the refractive index of the light transmissive member is smaller than the refractive index of the wavelength conversion member, when the first light is incident on the wavelength conversion member from the light transmissive member, it is possible to make it easy to cause the first light to enter the inside of the wavelength conversion member. Therefore, it is possible to make it easy to perform the wavelength conversion of the first light into the second light by the phosphor in the wavelength conversion member. When the difference between the refractive index of the light transmissive member and the refractive index of the wavelength conversion member is large, the first light incident on the wavelength conversion member and the second light obtained by wavelength conversion of the first light can be prevented from entering the light transmissive member from the side surface of the wavelength conversion member.

Furthermore, since the light transmissive member transmits light, absorption of the first light and the second light in the light transmissive member can be suppressed. Therefore, it is possible to suppress a decrease in the amount of the second light emitted from the angle conversion member.

### APPENDIX 2

The wavelength conversion element according to Appendix 1, wherein
the wavelength conversion member and the light transmissive member are in contact with each other.

According to such a configuration, an air layer can be prevented from being interposed between the wavelength conversion member and the light transmissive member. Therefore, the first light can be easily incident on the wavelength conversion member from the light transmissive member, and in addition, the first light can be prevented from being incident on the light transmissive member from the wavelength conversion member.

### APPENDIX 3

The wavelength conversion element according to one of Appendices 1 and 2, wherein
the side surface includes a plurality of partial side surfaces extending along the first direction and crossing each other, and
the light transmissive member is formed in a plate shape disposed so as to correspond to at least one of the plurality of partial side surfaces.

According to such a configuration, the light transmissive member can be easily attached to the wavelength conversion member. Therefore, the wavelength conversion element can be easily assembled.

### APPENDIX 4

The wavelength conversion element according to Appendix 3, wherein
the light transmissive member covers the side surface in a circumferential direction about an axis along the first direction.

According to such a configuration, the light transmissive member covers the entire side surface of the wavelength conversion member in the circumferential direction described above. For example, when the wavelength conversion member is formed in a rectangular parallelepiped shape having a first partial side surface and a second partial side surface facing to opposite sides and a third partial side surface and a fourth partial side surface facing to opposite sides and crossing the first partial side surface and the second partial side surface, respectively, the light transmissive member covers each of the partial side surfaces. According to this configuration, the contact area between the light transmissive member and the angle conversion member can be increased compared to when the light transmissive member is disposed only on one of the first to fourth partial side surfaces. Therefore, the wavelength conversion member and the light transmissive member can be stably bonded to the angle conversion member.

### APPENDIX 5

The wavelength conversion element according to one of Appendices 1 and 2, wherein
the light transmissive member is formed like a cylinder in which an arrangement portion where the wavelength conversion member is arranged is disposed.

According to such a configuration, the light transmissive member can be disposed on the periphery of the wavelength conversion member by disposing the wavelength conversion member in the arrangement portion. Therefore, since the light transmissive member can be easily attached to the wavelength conversion member, the wavelength conversion element can be easily assembled.

Since the light transmissive member covers the wavelength conversion member in the circumferential direction about the axis along the first direction, the wavelength conversion member and the light transmissive member can be stably bonded to the angle conversion member similarly to the above description.

### APPENDIX 6

The wavelength conversion element according to one of Appendices 1 to 5, wherein
the wavelength conversion member and the light transmissive member are fixed to each other with an adhesive material.

According to such a configuration, the wavelength conversion member and the light transmissive member can be integrated with each other.

### APPENDIX 7

The wavelength conversion element according to one of Appendices 1 and 2, wherein
the light transmissive member includes
a frame body configured to cover the side surface, and
a light transmissive liquid disposed between the frame body and the side surface and in contact with the side surface.

Here, the wavelength conversion member generates heat when converting the first light into the second light. When the temperature of the wavelength conversion member rises, the wavelength conversion efficiency from the first light to the second light decreases.

In contrast, since the light transmissive liquid in contact with the wavelength conversion member is provided inside the frame body, the wavelength conversion member can be cooled by the liquid. Therefore, a decrease in wavelength conversion efficiency due to the heat can be suppressed.

### APPENDIX 8

The wavelength conversion element according to Appendix 7, wherein
the side surface includes a first partial side surface on which the first light is incident, and
the frame body includes a light transmissive portion located at a second direction side to which the first partial side surface faces the wavelength conversion member and configured to transmit the first light.

According to such a configuration, the first light can be incident on the wavelength conversion member from the outside of the light transmissive member via the light transmissive portion. Therefore, it is possible to prevent the liquid in the frame body from leaking to the outside.

### APPENDIX 9

A light source device including:
the wavelength conversion element according to one of Appendices 7 and 8;
a light emitting element configured to emit the first light to the side surface; and
a flow mechanism configured to circulate the liquid.

According to such a configuration, it is possible to achieve substantially the same advantages as those of the wavelength conversion element.

Further, since the liquid can be circulated in the frame body by the flow mechanism, the cooling efficiency of the wavelength conversion member can be enhanced.

### APPENDIX 10

A light source device including:
the wavelength conversion element according to any one of Appendices 1 to 6; and
a light emitting element configured to emit the first light to the side surface.

According to such a configuration, it is possible to achieve substantially the same advantages as those of the wavelength conversion element.

### APPENDIX 11

The light source device according to one of Appendices 9 and 10, wherein
the light transmissive member is disposed at least between the light emitting element and the wavelength conversion member.

According to such a configuration, since the first light emitted from the light emitting element enters the wavelength conversion member via the light transmissive member, it is possible not to prevent the first light from entering the wavelength conversion member.

When the light transmissive member has a side surface that does not face the light transmissive member out of the side surfaces of the wavelength conversion member, the side surface can be used as a heat dissipation surface that dissipates heat of the wavelength conversion member.

### APPENDIX 12

A projector including:
the light source device according to any one of Appendices 9 to 11;
a light modulation device configured to modulate light including the second light emitted from the light source device; and
a projection optical device configured to project the light modulated by the light modulation device.

According to such a configuration, it is possible to obtain substantially the same advantages as those of the light source device described above.

What is claimed is:

1. A wavelength conversion element comprising:
a wavelength conversion member having a side surface extending in a first direction and a first surface crossing the side surface and disposed at one end in the first direction, and containing a phosphor configured to convert first light having a first wavelength band and incident on the side surface into second light having a second wavelength band different from the first wavelength band;
a light transmissive member which has a second surface disposed at one end in the first direction, is disposed at the side surface along the first direction, and is configured to transmit the first light and the second light; and
an angle conversion member bonded to the first surface and the second surface, and configured to convert an angle of light emitted from the first surface and the second surface, wherein
a refractive index of the light transmissive member is smaller than a refractive index of the wavelength conversion member.

2. The wavelength conversion element according to claim 1, wherein
the wavelength conversion member and the light transmissive member are in contact with each other.

3. The wavelength conversion element according to claim 1, wherein
the side surface includes a plurality of partial side surfaces extending along the first direction and crossing each other, and
the light transmissive member is formed in a plate shape disposed so as to correspond to at least one of the plurality of partial side surfaces.

4. The wavelength conversion element according to claim 3, wherein
the light transmissive member covers the side surface in a circumferential direction about an axis along the first direction.

5. The wavelength conversion element according to claim 1, wherein
the light transmissive member is formed like a cylinder in which an arrangement portion where the wavelength conversion member is arranged is disposed.

6. The wavelength conversion element according to claim 1, wherein
the wavelength conversion member and the light transmissive member are fixed to each other with an adhesive material.

7. The wavelength conversion element according to claim 1, wherein
the light transmissive member includes
a frame body configured to cover the side surface, and
a light transmissive liquid disposed between the frame body and the side surface and in contact with the side surface.

8. The wavelength conversion element according to claim 7, wherein
the side surface includes a first partial side surface on which the first light is incident, and
the frame body includes a light transmissive portion located at a second direction side to which the first partial side surface faces the wavelength conversion member and configured to transmit the first light.

9. A light source device comprising:
the wavelength conversion element according to claim 7;
a light emitting element configured to emit the first light to the side surface; and
a flow mechanism configured to circulate the liquid.

10. A light source device comprising:
the wavelength conversion element according to claim 1; and
a light emitting element configured to emit the first light to the side surface.

11. The light source device according to claim 9, wherein
the light transmissive member is disposed at least between the light emitting element and the wavelength conversion member.

12. A projector comprising:
the light source device according to claim 9;
a light modulation device configured to modulate light including the second light emitted from the light source device; and
a projection optical device configured to project the light modulated by the light modulation device.
